(19) United States
(12) Patent Application Publication
(10) Pub. No.: US 2019/0111684 A1
(43) Pub. Date: Apr. 18, 2019

(54) PRINTER AND HEAD UNIT

(71) Applicant: SEIKO EPSON CORPORATION, Tokyo (JP)

(72) Inventors: Kinya OZAWA, SHIOJIRI (JP); Seiichi TANIGUCHI, ASAHI (JP); Hidenori USUDA, MATSUMOTO (JP); Yasumasa NAKAJIMA, SHIOJIRI (JP)

(21) Appl. No.: 16/090,061

(22) PCT Filed: Mar. 21, 2017
(86) PCT No.: PCT/JP2017/011271

§ 371 Date: Sep. 28, 2018

(30) Foreign Application Priority Data
Mar. 29, 2016 (JP) 2016-065160
Mar. 29, 2016 (JP) 2016-065161
Mar. 29, 2016 (JP) 2016-065164

(51) Int. Cl. B41J 2/165

(52) U.S. Cl. CPC B41J 2/16517

(57) ABSTRACT

To provide a printer that can reduce adhesion of a mist to a liquid ejection surface and hence can reduce occurrence of a misprint.

A printer includes a head unit 16 including an ink jet head 11 that ejects liquid from a nozzle hole 13 of a nozzle row 14 being open in a liquid ejection surface 12 arranged on a surface facing a printing medium 3, and a carriage 10 on which the ink jet head 11 is mounted; a plasma actuator 20 that generates an airflow with respect to a platen gap; and a controller 30 that controls the head unit 16 and the plasma actuator 20.

### TECHNICAL FIELD

The present invention relates to a printer and a head unit.

### BACKGROUND ART

Hitherto, it is known that a mist of ink which is included in ink ejected from an ink jet head and which floats around without arriving at a printing medium or the like stays in a gap between an ink ejection surface and a platen, and the ink adheres to the ink ejection surface, resulting in a misprint.

The resistance is large and the flow of the air is small between the ink ejection surface and the platen. Hence, the mist staying in the platen gap adheres to the head due to self-jet of ink ejection or the like, resulting in a deterioration of printing reliability.

Owing to this, a technology is disclosed that inhibits the mist from adhering to the head by generating an airflow in the platen gap (for example, see PTL 1). Also, a technology is disclosed that inhibits the mist from adhering to the head by sucking an airflow below the platen (for example, see PTL 2).

### CITATION LIST

### Patent Literature

PTL 1: Japanese Patent No. 5,467,630

PTL 2: Japanese Unexamined Patent Application Publication No. 2007-038437

### SUMMARY OF INVENTION

### Technical Problem

However, the related art requires a large-scale airflow generating device, and thus the size of the printer is increased.

The invention is made in light of the situations, and an object of the invention is to provide a printer and a head unit that can reduce adhesion of a mist to a liquid ejection surface and can reduce occurrence of a misprint.

### Solution to Problem

To attain the object, a printer according to the invention includes a head unit including an ink jet head that ejects liquid from a nozzle row being open in a liquid ejection surface arranged on a surface facing a printing medium, and a support member on which the ink jet head is mounted; a plasma actuator that generates an airflow with respect to a platen gap; and a controller that controls liquid ejection from the nozzle row, and airflow generation of the plasma actuator.

With this configuration, since the airflow is generated by driving the plasma actuator, the air in the platen gap likely moves, and a mist around the liquid ejection surface can be discharged. Thus, a mist unlikely adheres to the liquid ejection surface, and occurrence of a misprint can be reduced. Also, since the plasma actuator is provided, a large-scale airflow generating device is not additionally required, and facilitation cost can be reduced.

According to the invention, the plasma actuator is arranged on the liquid ejection surface.

With this configuration, a mist around the liquid ejection surface can be efficiently discharged.

According to the invention, the plasma actuator is arranged beside the nozzle row.

With this configuration, an airflow in the movement direction of the carriage can be generated, and hence a mist around the liquid ejection surface can be efficiently discharged.

According to the invention, the plasma actuator includes at least two plasma actuators arranged on the liquid ejection surface with the nozzle row interposed therebetween.

With this configuration, a mist around the liquid ejection surface can be efficiently discharged. In addition, a mist can be efficiently discharged with the reciprocation of the carriage.

According to the invention, the plasma actuator is arranged on the support member.

With this configuration, since the plasma actuator is not mounted on the ink jet head, the ink jet head can be easily manufactured.

According to the invention, the plasma actuator is arranged at a position at a distance larger than a distance between the liquid ejection surface and the printing medium.

With this configuration, an airflow can be generated at a position separated from the liquid ejection surface, and a mist can be discharged by the airflow.

According to the invention, the plasma actuator is arranged on a surface intersecting with the liquid ejection surface.

With this configuration, by driving the plasma actuator, an airflow can be generated toward or away from the printing medium, and a mist can be discharged by the airflow.

According to the invention, an airflow generation region by the plasma actuator is longer than the nozzle row.

With this configuration, the airflow generation region due to the plasma actuator can be ensured in a region longer than the nozzle row, and a mist generated from the nozzle row can be reliably discharged.

According to the invention, the controller drives the plasma actuator to generate an airflow so that liquid droplets which are generated when the liquid is ejected from the nozzle row and which float around without arriving at the printing medium do not stay around the liquid ejection surface.

With this configuration, the liquid droplets which are generated when the liquid is ejected from the nozzle row and which float around without arriving at the printing medium can be discharged so as not to stay around the liquid ejection surface.

According to the invention, the controller drives the plasma actuator to generate an airflow when the liquid is not ejected from the nozzle row.

With this configuration, since the airflow is generated while the liquid is not ejected, for example, when high ink-landing precision is demanded such as a case of printing in a high-precision printing mode, the ink-landing precision can be further increased.

According to the invention, the controller does not drive the plasma actuator when the liquid is ejected from the nozzle row for printing.

With this configuration, since the airflow is not generated while the liquid is ejected, for example, when high ink-landing precision is demanded such as a case of printing in a high-precision printing mode, the ink-landing precision can be further increased.

According to the invention, the controller drives the plasma actuator to generate an airflow during a flushing operation by the head unit.

A mist is generated during liquid ejection by the flushing operation, and hence the ejection amount of liquid has been restricted to reduce the amount of mist. With this configuration, by driving the plasma actuator during the flushing operation, a mist can be discharged. Thus, the restriction for the ejection amount of liquid is eased, for example, flushing can be executed simultaneously for the entire nozzle row, and throughput can be increased.

According to the invention, the printer further includes a driving voltage generator that generates a driving voltage for driving the plasma actuator. The driving voltage generator is mounted on the ink jet head.

With this configuration, the driving voltage for the plasma actuator that is driven with a high voltage can be generated by the driving voltage generator. Thus, high voltage wiring is not required to be arranged in a flexible cable coupled to the carriage, and a problem does not arise in insulation, countermeasure for short-circuit, and countermeasure for noise.

According to the invention, the ink jet head includes wiring for supplying an ink jet driving voltage for driving the head unit, and the driving voltage generator generates a voltage for driving the plasma actuator by using the ink jet driving voltage.

With this configuration, since the voltage for driving the plasma actuator is generated by using the ink jet driving voltage supplied from the wiring, wiring dedicated for the plasma actuator is not required to be arranged in the flexible cable coupled to the carriage.

According to the invention, the support member is a carriage configured to reciprocate in a main-scanning direction, and the plasma actuator is arranged beside the nozzle row in a movement direction of the carriage.

With this configuration, an airflow in the movement direction of the carriage can be generated, and hence a mist around the liquid ejection surface can be efficiently discharged.

According to the invention, the plasma actuator is arranged beside the nozzle row to intersect with the nozzle row in a direction intersecting with the movement direction of the carriage.

With this configuration, an airflow in the direction intersecting with the movement direction of the carriage can be generated, and hence a mist around the liquid ejection surface can be efficiently discharged regardless of the movement direction of the carriage.

According to the invention, the controller controls driving of the plasma actuator to generate an airflow in accordance with the movement direction of the carriage.

With this configuration, by generating the airflow in accordance with the movement direction of the carriage, a mist can be efficiently discharged along with the movement of the carriage.

According to the invention, the ink jet head is a line-type ink jet head extending in a direction intersecting with a transport direction of the printing medium.

With this configuration, in the line-type ink jet head extending in the direction intersecting with the transport direction of the printing medium, a mist around the liquid ejection surface can be efficiently discharged.

According to the invention, the line-type ink jet head is configured such that a plurality of unit ink jet heads are arranged in a staggered manner.

With this configuration, even when the line-type ink jet head is configured such that the unit ink jet heads are arranged in a staggered manner, a mist of each unit ink jet head around the liquid ejection surface can be discharged.

According to the invention, the plasma actuator is arranged for each of the unit ink jet heads.

With this configuration, since the plasma actuator can be driven for each unit ink jet head, a mist of each unit ink jet head around the liquid ejection surface can be reliably discharged.

According to the invention, the plasma actuator includes a plurality of plasma actuators arranged in line.

With this configuration, since the plurality of plasma actuators are arranged, a plasma actuator corresponding to a nozzle hole that ejects the liquid can be driven.

According to the invention, the controller individually controls the plurality of plasma actuators to drive a plasma actuator corresponding to a nozzle that ejects the liquid.

With this configuration, since the plurality of plasma actuators are individually controlled, a plasma actuator corresponding to a nozzle hole that ejects the liquid can be individually driven. Thus, by generating an airflow only in a region where the liquid is ejected, and a mist around the liquid ejection surface can be efficiently discharged.

According to the invention, the plasma actuator is arranged separately from the ink jet head and the support member, and the controller drives the plasma actuator to generate an airflow for discharging a mist which is generated when the liquid is ejected from the nozzle row, from an area between the liquid ejection surface and the printing medium.

With this configuration, by driving the plasma actuator and generating airflows, the air in the platen gap likely moves, and a mist in the platen gap can be discharged. Thus, a mist unlikely adheres to the liquid ejection surface, and occurrence of a misprint can be reduced. Also, since the plasma actuator is provided, a large-scale airflow generating device is not additionally required, and facilitation cost can be reduced.

According to the invention, the printer further includes a flushing area where a flushing operation of the ink jet head is executed; and a flushing-area plasma actuator arranged in the flushing area. The flushing-area plasma actuator generates an airflow in a direction so that a mist generated during flushing is directed toward an ink recovery box in the flushing area.

With this configuration, by driving the flushing-area plasma actuator, a mist generated during flushing can be discharged to the ink recovery box in the flushing area. Also, flushing can be executed simultaneously for all nozzle rows, and throughput can be increased.

A head unit according to the invention includes a liquid ejection surface arranged on a surface facing a printing medium; a nozzle row that is open in the liquid ejection surface, and that ejects liquid to the printing medium; and a plasma actuator. The plasma actuator generates an airflow with respect to a space where the nozzle row ejects the liquid.

With this configuration, since the airflow is generated by driving the plasma actuator, the air in the space where the nozzle row ejects the liquid likely moves, and a mist around the liquid ejection surface can be discharged. Thus, a mist unlikely adheres to the liquid ejection surface, and occurrence of a misprint can be reduced. Also, since the plasma actuator is provided, a large-scale airflow generating device is not additionally required, and facilitation cost can be reduced.

### BRIEF DESCRIPTION OF DRAWINGS

FIG. 1 schematically illustrates a printer according to a first embodiment.

FIG. 2 is a schematic illustration of a head unit.

FIG. 3 is a schematic illustration when viewed from a liquid ejection surface in FIG. 2.

FIG. 4 is a cross-sectional view illustrating a basic structure of a plasma actuator.

FIG. 5 illustrates an example of generating airflows in a direction opposite to a movement direction of a carriage.

FIG. 6 illustrates an example of generating airflows toward nozzle rows.

FIG. 7 illustrates an example of generating airflows away from the nozzle rows.

FIG. 8 illustrates an example of generating an airflow away from the nozzle rows.

FIG. 9 illustrates an example of generating an airflow away from the nozzle rows.

FIG. 10 illustrates an example of generating an airflow toward the nozzle rows.

FIG. 11 illustrates an example of generating an airflow toward the nozzle rows.

FIG. 12 illustrates an example of generating airflows in a direction intersecting with the movement of the carriage.

FIG. 13 illustrates an example of generating airflows in the direction intersecting with the movement of the carriage.

FIG. 14 illustrates an example of generating airflows in the direction intersecting with the movement of the carriage.

FIG. 15 illustrates an example of generating airflows in the direction intersecting with the movement of the carriage.

FIG. 16 illustrates an example in which plasma actuators are mounted on the carriage.

FIG. 17 illustrates a modification of an arrangement structure of the plasma actuators.

FIG. 18 illustrates an example of generating airflows toward a printing medium.

FIG. 19 illustrates an example of generating airflows away from the printing medium.

FIG. 20 is a block diagram illustrating a functional configuration of the printer.

FIG. 21 is a timing chart illustrating driving timings.

FIG. 22 is a timing chart illustrating driving timings during multiple printing.

FIG. 23 is a schematic illustration of a head unit for full-color printing.

FIG. 24 is a schematic illustration when viewed from a liquid ejection surface in FIG. 23.

FIG. 25 is a schematic illustration of a head unit according to a second embodiment.

FIG. 26 schematically illustrates a printer according to a third embodiment.

FIG. 27 is a schematic illustration of a head unit.

FIG. 28 is a schematic illustration when viewed from a liquid ejection surface in FIG. 27.

FIG. 29 illustrates an example of generating airflows in the same direction as a transport direction of a printing medium.

FIG. 30 illustrates an example of generating airflows toward a nozzle row.

FIG. 31 illustrates an example of generating airflows away from the nozzle row.

FIG. 32 illustrates an example of generating an airflow away from the nozzle row.

FIG. 33 illustrates an example of generating an airflow toward the nozzle row.

FIG. 34 illustrates an example of generating airflows in a direction intersecting with the transport of the printing medium.

FIG. 35 illustrates an example of generating airflows in the direction intersecting with the transport of the printing medium.

FIG. 36 illustrates an example of generating airflows in the direction intersecting with the transport of the printing medium.

FIG. 37 illustrates an example of generating airflows in the direction intersecting with the transport of the printing medium.

FIG. 38 illustrates an example in which plasma actuators are mounted on a support member.

FIG. 39 illustrates a modification of an arrangement structure of the plasma actuators.

FIG. 40 illustrates an example of generating airflows toward the printing medium.

FIG. 41 illustrates an example of generating airflows away from the printing medium.

FIG. 42 is a block diagram illustrating a functional configuration of the printer.

FIG. 43 illustrates an example of an arrangement of unit ink jet heads.

FIG. 44 illustrates an example of an arrangement of a plurality of plasma actuators.

FIG. 45 is a schematic illustration of a head unit according to a fourth embodiment.

FIG. 46 schematically illustrates a printer according to a fifth embodiment.

FIG. 47 is a schematic illustration of an ink jet head.

FIG. 48 is a schematic illustration when viewed from a liquid ejection surface in FIG. 47.

FIG. 49 illustrates an example of generating airflows in a direction opposite to a movement direction of a carriage.

FIG. 50 illustrates an example of generating airflows away from the ink jet head.

FIG. 51 illustrates an example of generating airflows during flushing.

FIG. 52 illustrates an example in which unit plasma actuators are arranged.

FIG. 53 is a block diagram illustrating a functional configuration of the printer.

FIG. 54 is a schematic illustration of a printer according to a sixth embodiment.

FIG. 55 is a schematic illustration of a printer according to a seventh embodiment.

FIG. 56 is a schematic illustration of an ink jet head according to the seventh embodiment.

FIG. 57 is a schematic illustration when viewed from a liquid ejection surface in FIG. 56.

FIG. 58 illustrates an example of generating airflows away from the ink jet head.

FIG. 59 illustrates an example of generating airflows during flushing.

FIG. 60 illustrates an example in which unit plasma actuators are arranged.

### DESCRIPTION OF EMBODIMENTS

Embodiments of the invention are described below with reference to the drawings.

### First Embodiment

A first embodiment of the invention is described.

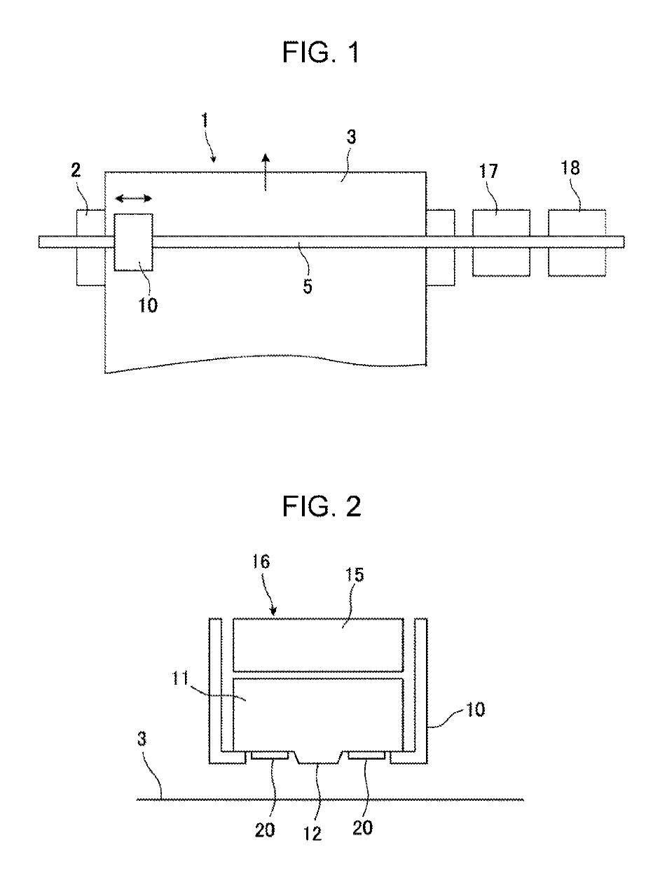

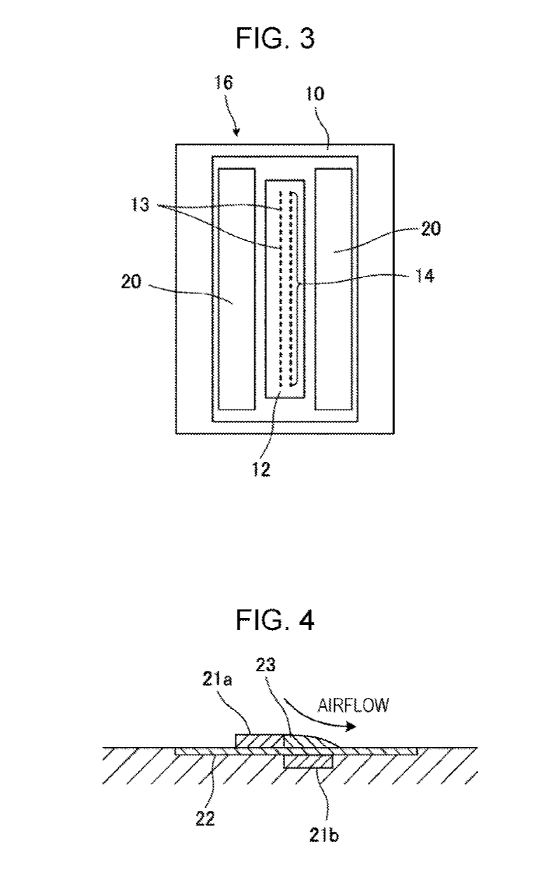

FIG. 1 is a schematic illustration of a printer according to the first embodiment. FIG. 2 is a schematic illustration of a head unit of the printer according to the first embodiment. FIG. 3 is a schematic illustration when viewed from a liquid ejection surface in FIG. 2.

As illustrated in FIG. 1, a printer 1 includes a flat-plate-shaped platen 2. A predetermined printing medium 3 is transported on an upper surface of the platen 2 in a sub-scanning direction by a paper feed mechanism (not illustrated). The platen 2 may be provided with an ink discarding region for no-margin printing.

The printing medium 3 may be rolled paper wound in a roll form, a cut sheet cut into a sheet with a predetermined length, and a continuous sheet in which a plurality of sheets are joined. Such a recording medium may be paper, such as normal paper, tracing paper, or thick paper; or a sheet such as one made of synthetic resin. Such a sheet treated with coating or dipping may be also used. Regarding the form of a cut sheet, for example, a standard-sized cut sheet, such as PPC paper or a postcard; a booklet form of a plurality of bound sheets such as a bankbook; or a bag-shaped object such as an envelope may be exemplified. Regarding the form of a continuous sheet, for example, continuous paper having sprocket holes in both end portions in a width direction and folded every predetermined length may be exemplified.

A guide shaft 5 that extends in a direction orthogonal to a transport direction of the printing medium 3 is provided above the platen 2. A carriage 10 is provided on the guide shaft 5 so that the carriage 10 can be driven to reciprocate along the guide shaft 5 via a driving mechanism (not illustrated).

An ink jet head 11 is mounted on the carriage 10. A surface of the ink jet head 11 facing the platen 2 is a liquid ejection surface 12. The liquid ejection surface 12 has a nozzle row 14 being open in the liquid ejection surface 12. The nozzle row 14 includes a plurality of nozzle holes 13 that eject liquid, for example, ink on the printing medium 3. In this embodiment, the nozzle row 14 includes two nozzle rows 14 formed in parallel to each other. In this case, a gap (space) between the liquid ejection surface 12 and the platen 2, or a gap (space) between the liquid ejection surface 12 and the printing medium 3 is generally called platen gap. An example of using ink as the liquid is described below.

The ink jet head 11 includes a driving element such as a piezoelectric element for ejecting liquid from each of the nozzle holes 13. Also, an ink cartridge 15 that supplies the ink jet head 11 with ink is mounted on the carriage 10.

The carriage 10, the ink jet head 11, and the ink cartridge 15 form a head unit 16.

In this embodiment, an example of using a single-color ink cartridge 15 is described. Alternatively, the ink cartridge 15 may be arranged at a location other than the head unit 16.

A flushing area 17 of the ink jet head 11 is provided on one side of the platen 2. By ejecting ink from the nozzle holes 13 of the ink jet head 11 to the flushing area 17, ink increased in viscosity is discharged. A gap between the flushing area 17 and the liquid ejection surface 12 is also called platen gap.

A cleaning area 18 including a cap (not illustrated) is provided on one side of the flushing area 17. By ejecting ink in the cleaning area 18 while the cap is attached so as to cover the nozzle rows 14 of the ink jet head 11, the nozzle holes 13 are cleaned.

Two plasma actuators 20 are arranged on the liquid ejection surface 12, which is a surface of the carriage 10 facing the platen 2, on both end portions in a movement direction of the carriage 10 with the nozzle rows 14 interposed therebetween. Each plasma actuator 20 is longer than the nozzle rows 14. The platen gap is typically narrow, and may be occasionally 1 mm or less. Hence, as illustrated in FIG. 2, each plasma actuator 20 has to be arranged on a surface recessed by one step from a surface where the nozzle rows 14 are arranged. The recessed surface also corresponds to the liquid ejection surface 12. Alternatively, the plasma actuator 20 may be embedded in the ink jet head 11 and the step may be eliminated, or may be arranged on a surface at a distance larger than the distance between the nozzle rows 14 and the platen 2.

FIG. 4 is a cross-sectional view illustrating a basic structure of the plasma actuator 20. As illustrated in FIG. 4, the plasma actuator 20 includes electrodes 21a and 21b that are two thin-film electrodes, and a dielectric layer 22 interposed between the electrodes 21a and 21b. When an alternating voltage of several kilovolts with frequencies of several kilohertz is applied between the two electrodes 21a and 21b, a plasma discharge 23 occurs in a portion between the upper electrode 21a and the dielectric layer 22. The plasma discharge 23 generates an airflow flowing from the upper electrode 21a toward the lower electrode 21b. By controlling application of the alternating voltage, the plasma actuator 20 can be easily controlled for generation and stop of an airflow, or an airflow rate. This feature is not easily provided by an airflow generating device such as a fan. Alternatively, two electrodes 21b may be prepared and arranged such that an electrode 21a is interposed between the electrodes 21b. Thus, an airflow generation direction can be controlled in forward and reverse directions by selecting one of the two electrodes 21b.

The plasma actuators 20 are arranged to generate airflows in the movement direction of the carriage 10. In this embodiment, the plasma actuators 20 are configured of two plasma actuators 20 arranged so that airflow generation directions of the plasma actuators 20 are opposite to each other.

With this configuration, an airflow can be generated on one side of the nozzle rows 14, to either of both directions in the movement direction of the carriage 10.

The arrangement of the plasma actuators 20 is not limited thereto, and the airflow generation direction may be desirably determined. The plasma actuators 20 may be arranged on only either of both sides of the nozzle rows 14, or may be arranged in a direction intersecting with the nozzle rows 14. Hereinafter, various arrangements and various airflow generation directions are exemplified. In the following drawing when the head unit 16 is viewed from the liquid ejection surface, a black arrow indicates the movement direction of the carriage 10, and a white blank arrow indicates an airflow generation direction.

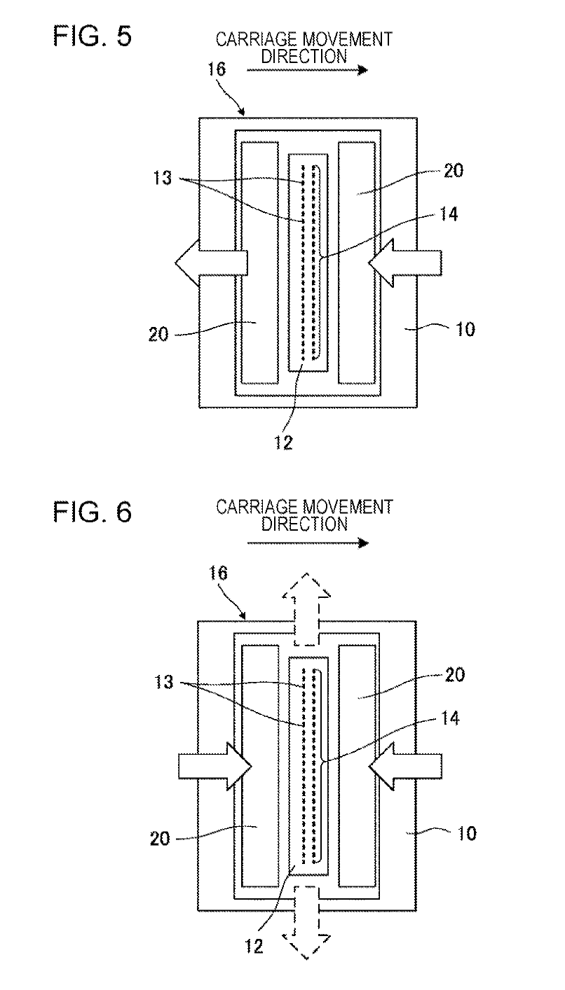

FIG. 5 illustrates an example of generating airflows in a direction opposite to the movement direction of the carriage 10 by the driving of the plasma actuators 20.

As illustrated in FIG. 5, the plasma actuators 20 generate airflows in the direction opposite to the movement direction of the carriage 10.

By generating the airflows in this way, the air in the platen gap likely moves with the movement of the carriage 10, and a mist around the liquid ejection surface 12 is discharged. A Karman vortex (swirl) is generated in the rear of the carriage 10 in the movement direction; however, by driving the plasma actuators 20 in this way, the generation of a Karman vortex can be suppressed. Thus, random diffusion of a mist into a casing of the printer 1 due to a Karman vortex can be reduced. Also, since the two plasma actuators 20 generate the airflows in the same direction, strong airflows are generated, and a mist around the liquid ejection surface 12 can be efficiently discharged.

Alternatively, airflows may be generated toward the downstream side in the movement direction of the carriage 10. Thus, a mist around the liquid ejection surface 12 can be discharged when the carriage 10 decelerates for stop, and the printing medium 3 is less likely contaminated with the mist.

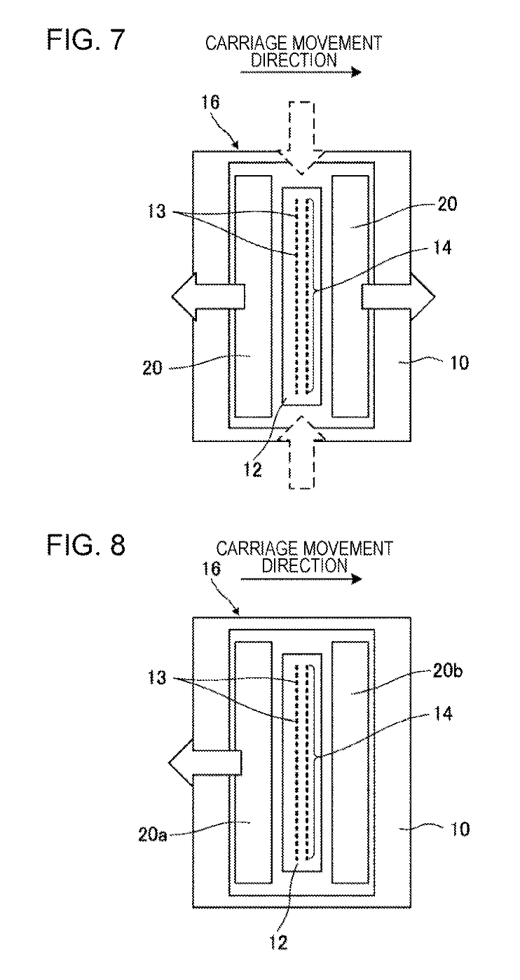

FIG. 6 illustrates an example of generating airflows toward the nozzle rows 14 by the driving of the plasma actuators 20. FIG. 7 illustrates an example of generating airflows away from the nozzle rows 14 by the driving of the plasma actuators 20.

As illustrated in FIG. 6, since the plasma actuators 20 generate the airflows toward the nozzle rows 14, as indicated by broken-line arrows in FIG. 6, a mist can be discharged in a direction orthogonal to the movement direction of the carriage 10.

Also, as illustrated in FIG. 7, since the plasma actuators 20 generate the airflows away from the nozzle rows 14, as indicated by broken-line arrows in FIG. 7, airflows enter in the direction orthogonal to the movement direction of the carriage 10, and a mist can be discharged away from the nozzle rows 14.

Since the airflows in the directions opposite to each other are generated at the plasma actuators 20, a mist in the platen gap can be discharged regardless of the movement direction of the carriage 10. In this case, the directions of the airflows to be generated by the plasma actuators 20 do not have to be changed in accordance with the movement direction of the carriage 10, and hence the structure of the printer can be simplified, and the cost can be reduced.

Regarding the plasma actuators 20 of this embodiment, only one of the plasma actuators 20 may be driven. Hereinafter, an example of the head unit 16 including plasma actuators 20a and 20b is described.

FIGS. 8 to 11 illustrate examples of driving only one of the plasma actuators 20 (20a, 20b).

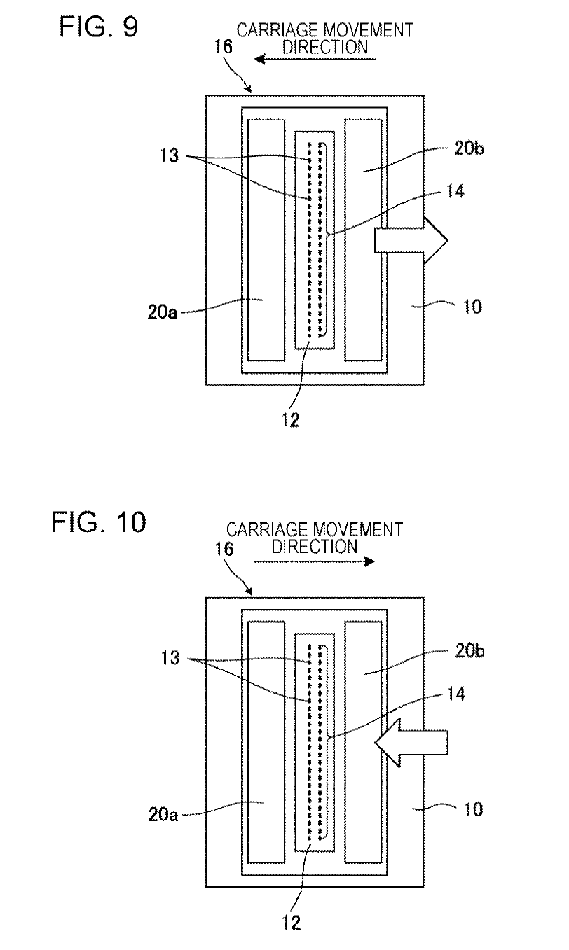

FIGS. 8 and 9 illustrate examples of generating an airflow away from the nozzle rows 14 when the plasma actuators 20a and 20b are arranged to generate airflows toward the nozzle rows 14.

As illustrated in FIG. 8, when the carriage 10 moves rightward in FIG. 8, only the plasma actuator 20a located on the upstream side in the movement direction of the carriage 10 is driven. Then, the plasma actuator 20a generates an airflow away from the nozzle rows 14. Also, as illustrated in FIG. 9, when the carriage 10 moves leftward in FIG. 9, only the plasma actuator 20b located on the upstream side in the movement direction of the carriage 10 is driven. Then, the plasma actuator 20b generates an airflow away from the nozzle rows 14.

By driving the plasma actuators 20 in this way, the reciprocation of the carriage 10 can be handled. Also, by generating the airflow away from the nozzle rows 14, a mist in the platen gap can be efficiently discharged in the direction opposite to the movement direction of the carriage 10. Alternatively, the airflow generation direction may be the same direction as the movement direction of the carriage 10.

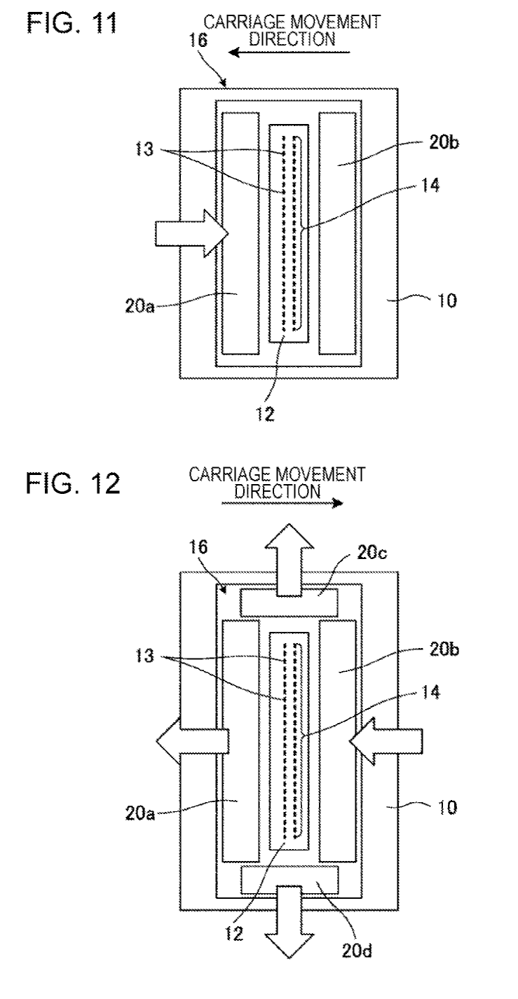

FIGS. 10 and 11 illustrate examples of generating an airflow toward the nozzle rows 14 when the plasma actuators 20a and 20b are arranged to generate airflows toward the nozzle rows 14.

As illustrated in FIG. 10, when the carriage 10 moves rightward in FIG. 10, only the plasma actuator 20b located on the downstream side in the movement direction of the carriage 10 is driven. Then, the plasma actuator 20b generates an airflow toward the nozzle rows 14. Also, as illustrated in FIG. 11, when the carriage 10 moves leftward in FIG. 11, only the plasma actuator 20a located on the downstream side in the movement direction of the carriage 10 is driven. Then, the plasma actuator 20a generates an airflow toward the nozzle rows 14.

By driving the plasma actuators 20a and 20b in this way, the reciprocation of the carriage 10 can be handled. Also, by generating the airflow toward the nozzle rows 14, a mist in the platen gap can be efficiently discharged in the direction opposite to the movement direction of the carriage 10. Alternatively, the airflow generation direction may be the same direction as the movement direction of the carriage 10.

FIGS. 12 to 15 illustrate modifications in which plasma actuators 20 are arranged also in a direction intersecting with the movement direction of the carriage 10.

FIG. 12 illustrates an example in which the plasma actuators 20a and 20b on both end portions in the movement direction of the carriage 10 generate airflows in the same direction, and plasma actuators 20c and 20d arranged in the intersection direction generate airflows away from the nozzle rows 14.

By driving the plasma actuators 20 in this way, a mist present in a portion of the platen gap can be evenly and efficiently discharged. Also, since a mist is discharged in three directions, the discharged mist does not unevenly stay in a specific location in the printer 1.

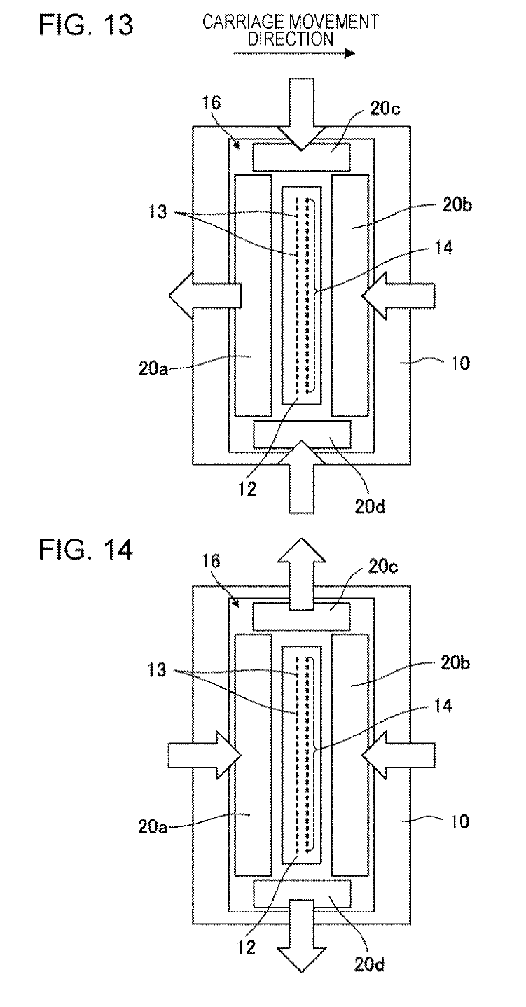

FIG. 13 illustrates an example in which the plasma actuators 20a and 20b on both end portions in the movement direction of the carriage 10 generate airflows in the same direction, and the plasma actuators 20c and 20d arranged in the intersection direction generate airflows toward the nozzle rows 14.

By driving the plasma actuators 20 in this way, the air can be sucked in three directions, and hence a mist present in a portion of the platen gap can be evenly and efficiently discharged in the direction opposite to the movement direction of the carriage 10. Alternatively, the airflow generation direction may be the same direction as the movement direction of the carriage.

FIG. 14 illustrates an example in which the plasma actuators 20a and 20b on both end portions in the movement direction of the carriage 10 generate airflows toward the nozzle rows 14, and the plasma actuators 20c and 20d arranged in the intersection direction generate airflows away from the nozzle rows 14.

By driving the plasma actuators 20 in this way, strong airflows can be generated, and hence a mist in the platen gap can be efficiently discharged in the direction intersecting with the movement direction of the carriage 10. Also, the directions of the airflows to be generated by the plasma actuators 20a to 20d do not have to be changed in accordance with the movement direction of the carriage 10, and hence the structure of the printer can be simplified, and the cost can be reduced.

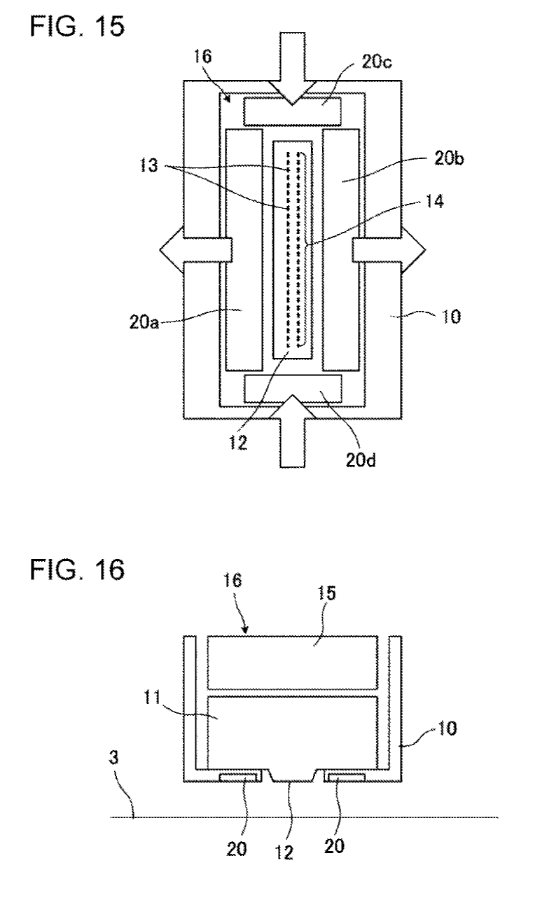

FIG. 15 illustrates an example in which the plasma actuators 20a and 20b on both end portions in the movement direction of the carriage 10 generate airflows away from the nozzle rows 14, and the plasma actuators 20c and 20d arranged in the intersection direction generate airflows toward the nozzle rows 14.

By driving the plasma actuators 20 in this way, strong airflows can be generated, airflows enter in a direction orthogonal to the movement direction of the carriage 10, and hence, a mist in the platen gap and a head gap can be discharged away from the nozzle rows 14. Also, the directions of the airflows to be generated by the plasma actuators 20a to 20d do not have to be changed in accordance with the movement direction of the carriage 10, and hence the structure of the printer can be simplified, and the cost can be reduced.

Alternatively, the plasma actuators 20 may be arranged only in the direction intersecting with the movement direction of the carriage 10.

FIG. 16 illustrates an example in which the plasma actuators 20 are mounted on the carriage 10. As illustrated in FIG. 16, the plasma actuators 20 are mounted on the carriage 10 such that the plasma actuators 20 are embedded in the carriage 10. Thus, since the plasma actuators 20 are not mounted on the ink jet head 11, the ink jet head 11 can be simply configured, and easily manufactured.

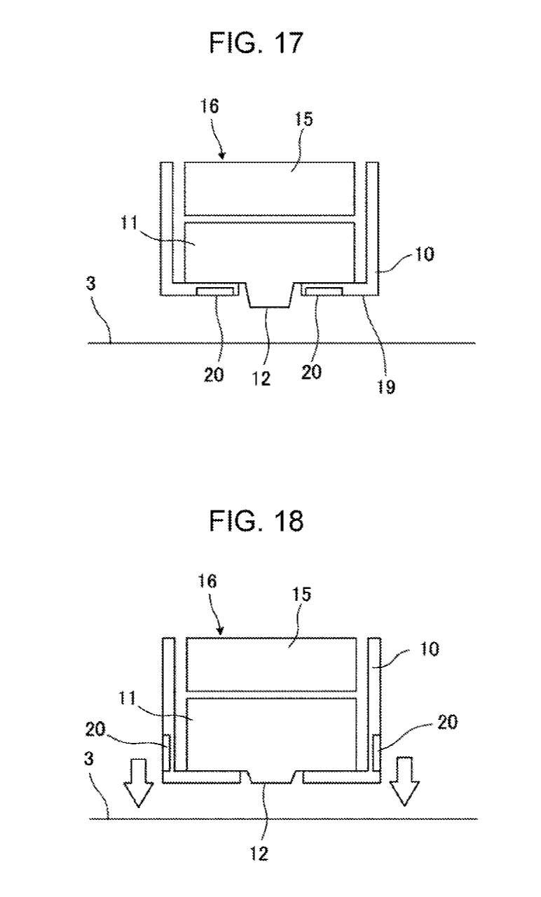

FIG. 17 illustrates a modification of an arrangement structure of the plasma actuators 20. As illustrated in FIG. 17, step surfaces 19 may be formed at the carriage 10 at positions farther from the printing medium 3 than the liquid ejection surface of the ink jet head 11, and the plasma actuators 20 may be arranged on the step surfaces 19.

Even when the plasma actuators 20 are arranged on the ink jet head 11 as illustrated in FIG. 2, step surfaces 19 may be likewise formed at the ink jet head 11. Thus, the distance between the plasma actuators 20 and the platen 2 or the printing medium 3 is larger than the platen gap, and a mist can be efficiently discharged.

Even in the cases of FIGS. 16 and 17, the surfaces on which the plasma actuators 20 are arranged can be called the liquid ejection surface 12.

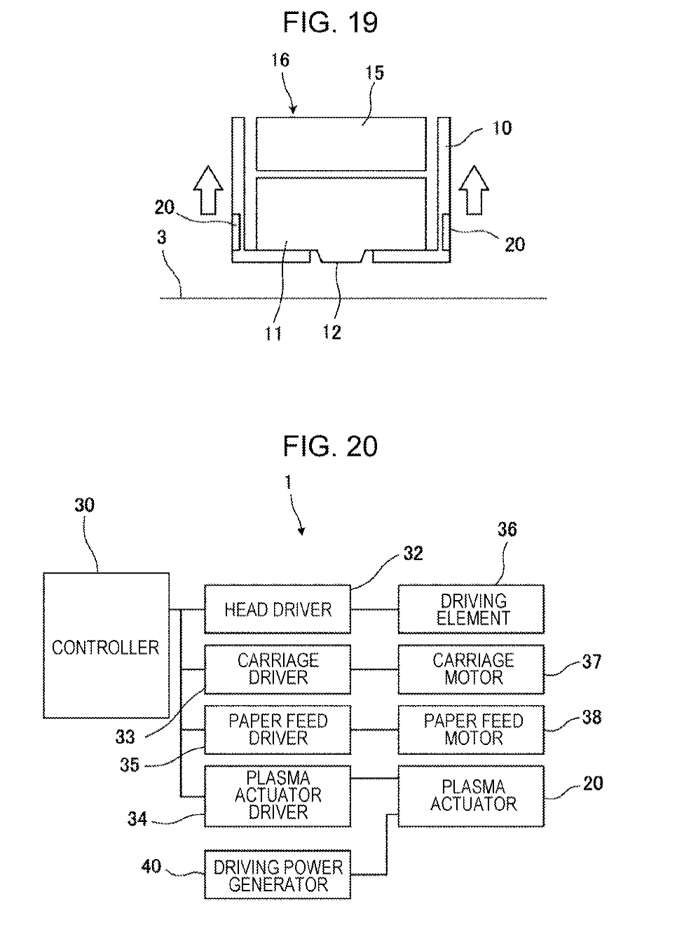

FIGS. 18 and 19 illustrate modifications of arrangements of the plasma actuators 20.

The plasma actuators 20 in the modifications are arranged on side surfaces of the carriage 10.

FIG. 18 illustrates an example in which the plasma actuators 20 generate airflows downward, that is, toward the printing medium 3.

As illustrated in FIG. 18, since the plasma actuators 20 generate the airflows toward the printing medium 3, a mist in the platen gap lands on a surface of the printing medium 3 through the generated downward airflows, and the mist does not adhere to the liquid ejection surface 12.

FIG. 19 illustrates an example in which the plasma actuators 20 generate airflows upward, that is, away from the printing medium 3.

As illustrated in FIG. 19, since the plasma actuators 20 generate the airflows away from the printing medium 3, a mist staying around the liquid ejection surface 12 can be moved away from the liquid ejection surface 12. Alternatively, in the examples of FIGS. 18 and 19, the plasma actuators 20 may be mounted on the ink jet head 11.

A control configuration of this embodiment is described next.

FIG. 20 is a block diagram illustrating a functional configuration of the printer 1 according to this embodiment.

As illustrated in FIG. 20, the printer 1 includes a controller 30 that controls respective devices, and various driver circuits that drive various motors and so forth under the control of the controller 30 and output a detection state of a detection circuit to the controller 30. The various driver circuits include a head driver 32, a carriage driver 33, a plasma actuator driver 34, and a paper feed driver 35.

The controller 30 centrally controls the respective devices of the printer 1. The controller 30 includes, for example, a CPU, a ROM that stores an executable basic control program and data relating to the basic control program in a non-volatile manner, a RAM that temporarily stores a program to be executed by the CPU and predetermined data, and other peripheral circuits.

The head driver 32 is coupled to a driving element 36 such as a piezoelectric element for ejecting ink. The driving element 36 is driven under the control of the controller 30, and causes ink to be ejected from the nozzle hole 13 by a required amount.

The carriage driver 33 is coupled to a carriage motor 37, and outputs a driving signal to the carriage motor 37 to operate the carriage motor 37 in a range instructed by the controller 30.

The plasma actuator driver 34 is coupled to each plasma actuator 20, and outputs a driving signal to the plasma actuator 20 to drive the plasma actuator 20 through the controller 30.

The paper feed driver 35 is coupled to a paper feed motor 38, and outputs a driving signal to the paper feed motor 38 to operate the paper feed motor 38 by an amount instructed by the controller 30. The printing medium 3 is transported in the transport direction by a predetermined amount in accordance with the operation of the paper feed motor 38.

To drive each plasma actuator 20, a high voltage is required. The printer 1 includes a driving voltage generator 40 that generates a driving voltage for driving the plasma actuator 20. The driving voltage generator 40 is coupled to the plasma actuator 20. Alternatively, the driving voltage generator 40 may be coupled to the plasma actuator driver 34.

With a serial printer, a flexible cable that transmits a head driving signal is arranged on the movable carriage 10. It is not desirable to additionally arrange high-voltage wiring for driving the plasma actuator 20 in the flexible cable because a problem may arise in distance for insulation, countermeasure for short-circuit, and countermeasure for noise.

Owing to this, in this embodiment, a low-voltage power supply line is arranged in the flexible cable, and the driving voltage generator 40 is mounted on the head unit 16. The driving voltage generator 40 uses its low-voltage power as an input voltage, and raises the input voltage to a high voltage in the head unit 16.

When a piezoelectric element is used for the driving element 36, since the power supply line for driving the piezoelectric element is arranged in the flexible cable, a power for driving the piezoelectric element may be used as an input voltage to the driving voltage generator 40. Also when a thermal-type driving element is used for the driving element 36, a power for driving the thermal head may be used as an input voltage to the driving voltage generator 40 likewise. Of course, an independent low-voltage power line may be arranged in the flexible cable.

Note that, unless a problem arises in distance for insulation, countermeasure for short-circuit, and countermeasure for noise, high-voltage wiring for driving the plasma actuator 20 may be arranged in the flexible cable, or another cable for high-voltage wiring different from the flexible cable for transmitting the head driving signal may be arranged.

The controller 30 controls driving of the plasma actuator 20 via the plasma actuator driver 34.

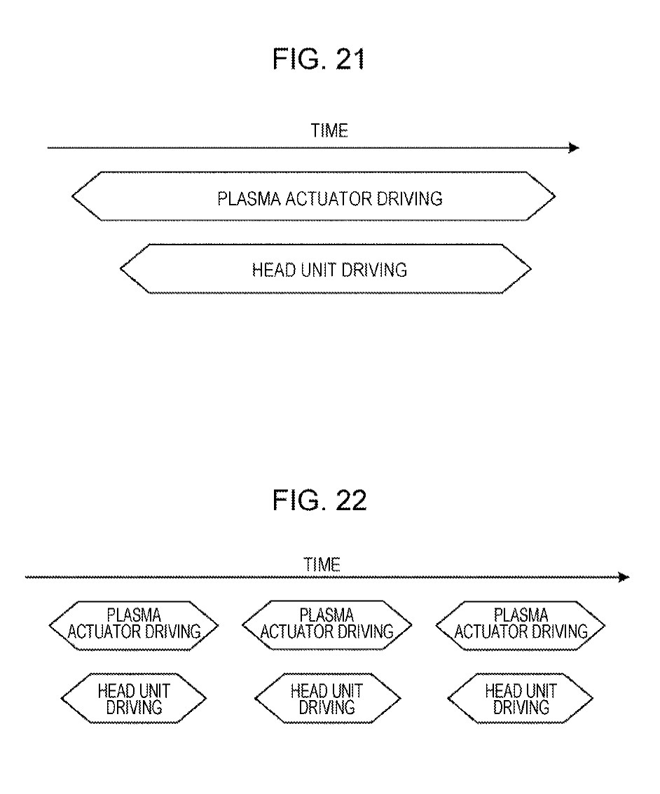

FIG. 21 is a timing chart illustrating a driving timing of the plasma actuator 20 with respect to a printing timing of the ink jet head 11. FIG. 22 is a timing chart illustrating driving timings of the plasma actuator 20 when plural printing timings of the ink jet head 11 are present in one passage of the carriage 10.

As illustrated in FIGS. 21 and 22, for example, in comparison to a timing at which the driving element 36 of the ink jet head 11 is driven and ink is ejected, the controller 30 performs control to start the driving of the plasma actuator 20 earlier than the ejection start of ink. Also, the controller 30 performs control to end the driving of the plasma actuator 20 later than the ejection end of ink.

By driving the plasma actuator 20 earlier than the ejection start of ink, a mist staying before ink ejection can be discharged, and a mist just after the ejection start of ink can be discharged. By ending the driving of the plasma actuator 20 later than the ejection end of ink, a mist staying during printing can be discharged.

Also, the controller 30 may perform control to drive the plasma actuator 20 to generate airflows when ink is not ejected from the ink jet head 11. That is, the controller 30 performs control not to drive the plasma actuator 20 when ink is ejected from the ink jet head 11.

With this control, for example, when high ink-landing precision is demanded in such a case of printing in a high-precision printing mode, the ink-landing precision can be further increased.

With a serial printer, in some cases, ink is not ejected, for example, during paper feed, when the carriage 10 moves to a printing position or the flushing area 17, or when the carriage 10 is stopped. Thus, a mist may be discharged by driving the plasma actuator 20 in this case.

In particular, mists are more generated during the flushing operation when the adjacent nozzle rows 14 are simultaneously driven. In related art, the flushing operation has been executed while the adjacent nozzle rows are not simultaneously driven. However, in this embodiment, by driving the plasma actuator 20 during the flushing operation, a mist can be efficiently discharged. Flushing can be executed simultaneously for all nozzle rows 14, and throughput can be increased.

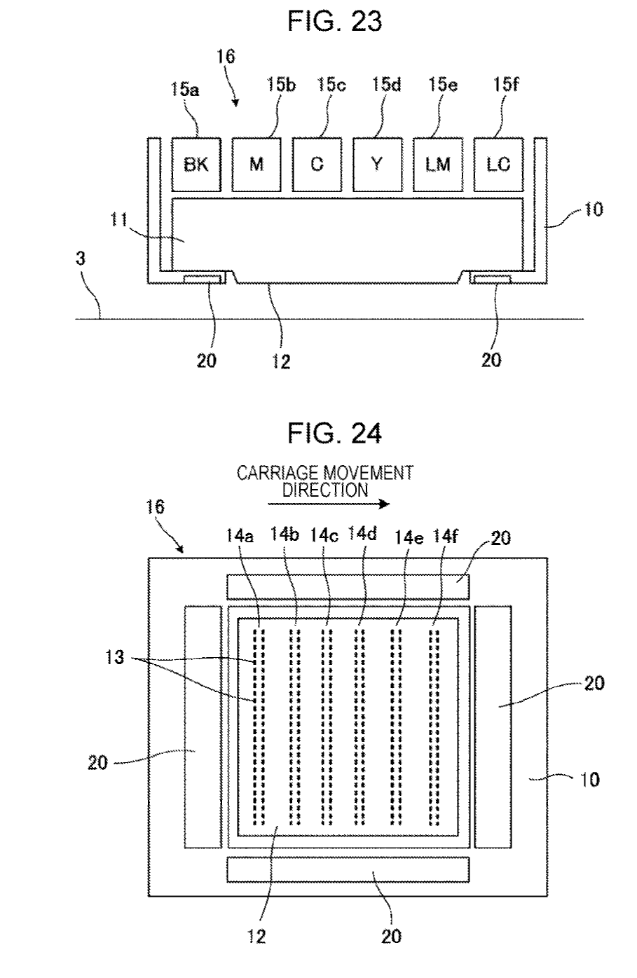

While the head unit 16 including the ink jet head 11 with single-color ink is used as the head unit 16 according to this embodiment, the invention is not limited thereto. For example, a head unit 16 illustrated in FIGS. 23 and 24 may be used.

FIG. 23 schematically illustrates the head unit 16 on which a plurality of colors of nozzle rows and ink cartridges are mounted for full-color printing. FIG. 24 is an illustration when viewed from the liquid ejection surface in FIG. 23.

That is, as illustrated in FIGS. 23 and 24, a plurality of colors (in this case, six colors) of nozzle rows 14a, 14b, 14c, 14d, 14e, and 14f are formed in the liquid ejection surface 12 of the ink jet head 11 mounted on the carriage 10. Ink cartridges 15a, 15b, 15c, 15d, 15e, and 15f that supply the ink jet head 11 with the respective colors of ink are mounted on the carriage 10. The ink cartridges 15a, 15b, 15c, 15d, 15e, and 15f store the respective colors of ink of black (BK), magenta (M), cyan (C), yellow (Y), light magenta (LM), and light cyan (LC).

The plasma actuators 20 are arranged on both end portions in the movement direction of the carriage 10. Also, the plasma actuators 20 are also arranged in the direction intersecting with the movement direction of the carriage 10 of the plasma actuators 20.

By arranging the plasma actuators 20 in this way, a mist in the platen gap can be discharged even in the case of the head unit 16 that performs full-color printing.

In this case, plasma actuators 20 may be arranged between the nozzle rows 14 of the respective colors. Also, as described above with reference to FIGS. 5 to 19, the various arrangements and the various airflow directions of the plasma actuators 20 can be applied.

While the plasma actuators 20 are arranged on the liquid ejection surface 12 of the ink jet head 11 or the carriage 10 according to this embodiment, the invention is not limited thereto. For example, if a separate moving member that moves in synchronization with the carriage 10 is provided, the plasma actuators 20 may be arranged on this moving member.

Alternatively, the plasma actuators 20 may be formed as a unit, and the unit may be arranged in a manner attachable to and detachable from the ink jet head 11, the carriage 10, or the moving member.

A printing method of this embodiment is described next.

When the printer 1 performs printing, the controller 30 performs control on the head driver 32, the carriage driver 33, and the paper feed driver 35. Thus, by driving the driving element 36 while driving the carriage motor 37 to reciprocate the carriage 10, ink is ejected from the nozzle holes 13, and thus printing is performed on the printing medium 3.

After the printing is performed on the printing medium 3 through the reciprocation of the carriage 10, the paper feed motor 38 is driven to transport the printing medium 3 by a predetermined amount in the transport direction. Then, the printing is performed on the printing medium 3 again while the carriage 10 is moved.

In this case, the controller 30 outputs a driving signal to the plasma actuator 20, and causes the plasma actuator 20 to be driven. The plasma actuator 20 may be driven in any of the above-described ways.

Thus, by driving the plasma actuator 20 and generating airflows, the air in the platen gap likely moves, and a mist in the platen gap can be discharged.

As described above, the printer 1 according to the embodiment to which the invention is applied includes the head unit 16 including the ink jet head 11 that ejects liquid from the nozzle rows 14 arranged on the surface facing the printing medium 3, and the carriage 10 on which the ink jet head 11 is mounted. Also, the printer 1 includes the plasma actuator 20 that generates an airflow for the liquid ejected from the nozzle rows 14, and the controller 30 that controls the head unit 16 and the plasma actuator 20.

Accordingly, since the airflow is generated by driving the plasma actuator 20, the air in the platen gap likely moves, and a mist around the liquid ejection surface 12 can be discharged. Thus, a mist unlikely adheres to the liquid ejection surface 12, and occurrence of a misprint can be reduced. Also, since the plasma actuator 20 is provided, a large-scale airflow generating device is not additionally required, and facilitation cost can be reduced.

In an example of this embodiment, the plasma actuator 20 may be arranged on the liquid ejection surface 12.

Accordingly, a mist around the liquid ejection surface 12 can be efficiently discharged.

Also, at least two plasma actuators 20 may be arranged on the liquid ejection surface 12 with the nozzle rows 14 interposed therebetween.

Accordingly, when the carriage 10 reciprocates, a mist can be discharged.

In an example of this embodiment, the plasma actuator 20 may be arranged beside the nozzle rows 14 in the movement direction of the carriage 10.

Accordingly, an airflow can be generated in the movement direction of the carriage 10, and when the carriage 10 reciprocates, a mist can be discharged in the movement direction of the carriage 10.

In an example of this embodiment, the plasma actuator 20 may be arranged in parallel in a direction intersecting with the movement direction of the carriage 10, to intersect with the nozzle rows 14.

Accordingly, an airflow can be generated in the direction intersecting with the movement direction of the carriage 10, and a mist can be discharged in the direction intersecting with the movement direction of the carriage 10.

In an example of this embodiment, the plasma actuator 20 may be arranged on the carriage 10.

Accordingly, by driving the plasma actuator 20, an airflow can be generated at the carriage 10, and when the carriage 10 reciprocates, a mist can be discharged.

In an example of this embodiment, the plasma actuator 20 may be arranged at a position at a distance larger than the distance between the liquid ejection surface 12 and the printing medium 3.

Accordingly, an airflow can be generated at a position separated from the liquid ejection surface 12, and a mist can be discharged by the airflow.

In an example of this embodiment, the plasma actuator 20 may be arranged on a surface intersecting with the liquid ejection surface 12.

Accordingly, by driving the plasma actuator 20, an airflow can be generated toward or away from the printing medium 3, and a mist can be discharged by the airflow.

In an example of this embodiment, an airflow generation region due to the plasma actuator 20 may be longer than the nozzle rows 14.

Accordingly, the airflow generation region due to the plasma actuator 20 can be ensured in a region longer than the nozzle rows 14, and a mist generated from the nozzle rows 14 can be reliably discharged.

In an example of this embodiment, the controller 30 may drive the plasma actuator 20 to generate an airflow so that liquid droplets which are generated when liquid is ejected from the nozzle rows 14 and which float around without arriving at the printing medium do not stay around the liquid ejection surface 12.

Accordingly, the liquid droplets (mist) which are generated when liquid is ejected from the nozzle rows 14 and which float around without arriving at the printing medium can be discharged so as not to stay around the liquid ejection surface.

In an example of this embodiment, the controller 30 may cause an airflow to be generated in accordance with the movement direction of the carriage 10 by controlling the driving of the plasma actuator 20.

Accordingly, by generating the airflow in accordance with the movement direction of the carriage 10, a mist can be efficiently discharged with the movement of the carriage 10.

In an example of this embodiment, the controller 30 may drive the plasma actuator 20 to generate an airflow when liquid is not ejected from the nozzle rows 14.

Accordingly, for example, when high ink-landing precision is demanded such as a case of printing in a high-precision printing mode, an airflow is not generated, and the ink-landing precision can be further increased.

In an example of this embodiment, the controller 30 may not drive the plasma actuator 20 when liquid is ejected from the nozzle rows 14 for printing.

Accordingly, for example, when high ink-landing precision is demanded such as a case of printing in a high-precision printing mode, an airflow is not generated, and the ink-landing precision can be further increased.

In an example of this embodiment, the controller 30 may drive the plasma actuator 20 to generate an airflow during a flushing operation by the ink jet head 11.

Accordingly, a large amount of mists are generated when ink is ejected during the flushing operation, the mists are discharged by driving the plasma actuator 20 during the flushing operation. Thus, flushing can be executed simultaneously for all nozzle rows 14, and throughput can be increased.

In an example of this embodiment, the driving voltage generator 40 that generates a driving voltage for driving the plasma actuator 20 is further provided. The driving voltage generator 40 may be mounted on the head unit 16.

Accordingly, the driving voltage for the plasma actuator 20 that is driven with a high voltage can be generated by the driving voltage generator 40. Thus, high voltage wiring is not required to be arranged in the flexible cable provided on the carriage 10, and a problem does not arise in insulation, countermeasure for short-circuit, and countermeasure for noise.

In an example of this embodiment, the head unit 16 includes wiring for supplying an ink jet driving voltage for driving the ink jet head 11, and the driving voltage generator 40 may generate a voltage for driving the plasma actuator 20 by using the ink jet driving voltage.

Accordingly, since the voltage for driving the plasma actuator 20 is generated by using the wiring that supplies the ink jet driving voltage, a power source dedicated for the plasma actuator 20 is not required.

In an example of this embodiment, the plasma actuator 20 may be attachable and detachable.

Accordingly, the plasma actuator 20 can be easily exchanged when the plasma actuator 20 is contaminated with a mist or broken.

In an example of this embodiment, the plasma actuator 20 may generate an airflow in a direction opposite to the movement direction of the carriage 10.

Accordingly, by generating the airflow in the direction opposite to the movement direction of the carriage 10, a mist can be discharged to the downstream side when the carriage 10 moves.

In an example of this embodiment, the at least two plasma actuators 20 arranged on the liquid ejection surface 12 with the nozzle rows 14 interposed therebetween may generate airflows in direction opposite to each other.

Accordingly, since the plasma actuators 20 generate the airflows in the direction opposite to each other, a mist can be discharged toward the nozzle rows 14 or away from the nozzle rows 14.

### Second Embodiment

A second embodiment of the invention is described next.

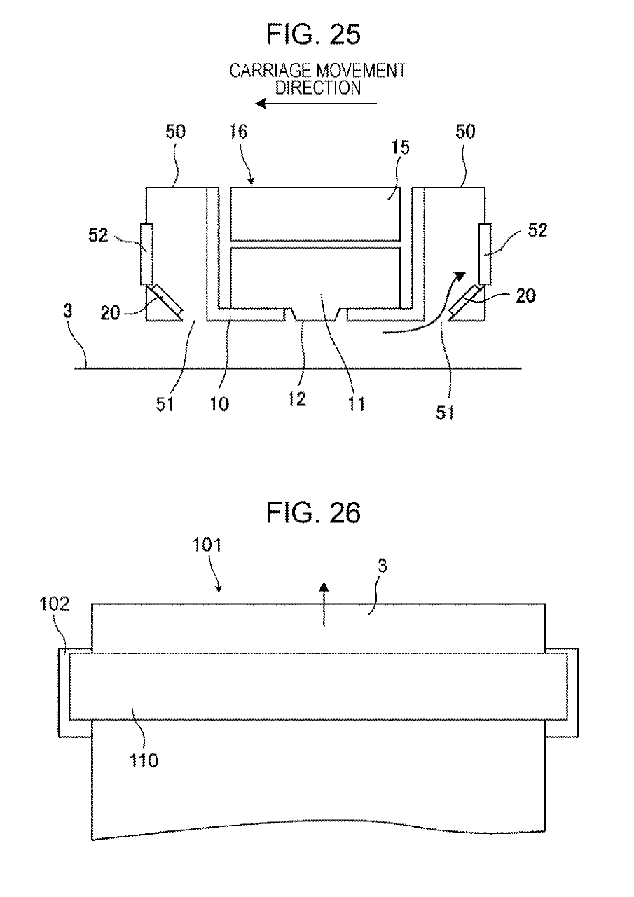

FIG. 25 is a schematic illustration of a head unit 16 according to the second embodiment of the invention. Note that the same reference sings are applied to the same portions as those of the first embodiment, and the description thereof is omitted.

As illustrated in FIG. 25, mist recovery containers 50 are provided on both sides of the carriage 10. Each of the mist recovery containers 50 has an opening 51 near the liquid ejection surface 12 of the ink jet head 11.

A plasma actuator 20 that generates an airflow to recover a mist from the opening 51 is arranged in the mist recovery container 50. A filter 52 that recovers the mist sent into the mist recovery container 50 is arranged on a side surface of the mist recovery container 50.

The filter 52 is attachable and detachable. Alternatively, the inside of the mist recovery container 50 may be entirely filled with the filter 52 of, for example, sponge.

In this embodiment, when the carriage 10 moves, the plasma actuator 20 located on a side opposite to the movement direction of the carriage 10 is driven. Accordingly, an airflow from the opening 51 toward the filter 52 is generated in the mist recovery container 50 as indicated by an arrow in the drawing. With this airflow, a mist around the liquid ejection surface 12 enters the mist recovery container 50 from the opening 51, and is recovered by the filter 52. Alternatively, a mist may be recovered by driving the plasma actuator 20 arranged on the downstream side in the movement direction of the carriage 10, or a mist may be recovered by driving the plasma actuator 20 while the carriage 10 is stopped.

As described above, in this embodiment, the filter 52 that recovers a mist is provided in a downstream portion of the airflow generated by the plasma actuator 20, and the filter 52 is attachable and detachable.

Accordingly, by driving the plasma actuator 20, a mist generated from the nozzle rows 14 can be recovered by the filter 52. Also, since the filter 52 is attachable and detachable, the filter 52 can be easily exchanged, for example, when the filter 52 is contaminated.

While the filter 52 is attachable and detachable in the second embodiment, the invention is not limited thereto. For example, the mist recovery container 50 may be entirely exchanged instead of exchanging only the filter 52.

### Third Embodiment

A third embodiment of the invention is described next.

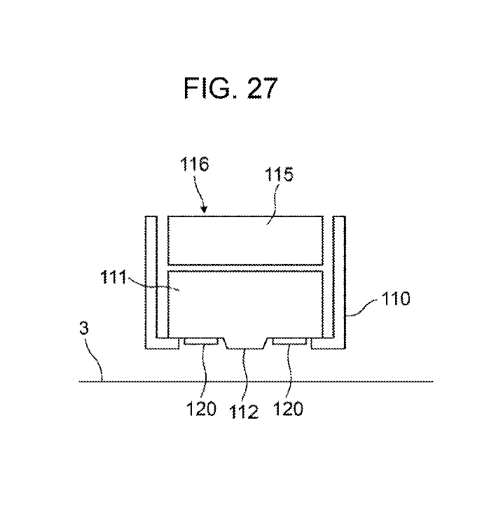

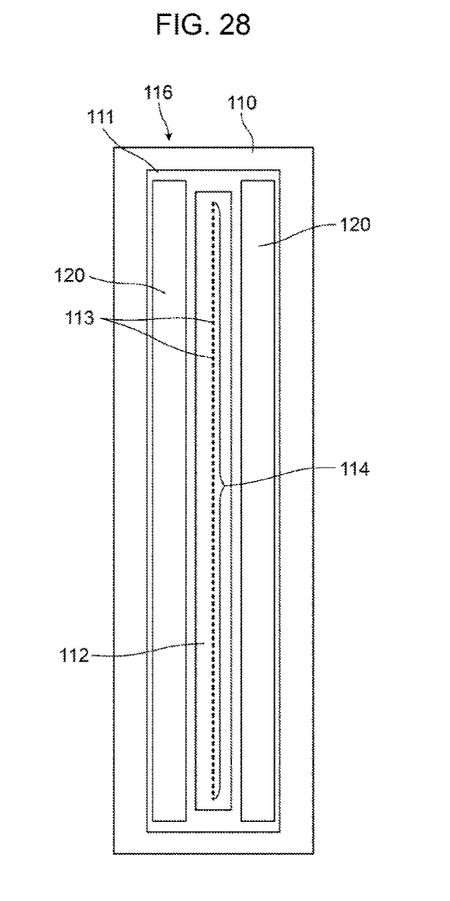

FIG. 26 is a schematic illustration of a printer according to the third embodiment. FIG. 27 is a schematic illustration of a head unit of the printer according to the third embodiment. FIG. 28 is a schematic illustration when viewed from a liquid ejection surface in FIG. 27.

As illustrated in FIG. 26, a printer 101 is an ink jet printer and includes a flat-plate-shaped platen 102. A predetermined printing medium 3 is transported on an upper surface of the platen 102 in a sub-scanning direction by a printing-medium transport portion. The platen 102 may be provided with an ink discarding region for no-margin printing.

The printing medium 3 is similar to that of the above-described embodiment and hence the description is omitted.

A support member 110 that extends in a direction intersecting with a transport direction of the printing medium 3 is provided above the platen 102. The support member 110 includes a linear head unit 116.

A surface of an ink jet head 111 facing the platen 102 is a liquid ejection surface 112. The liquid ejection surface 112 has a nozzle row 114 being open in the liquid ejection surface 112. The nozzle row 114 includes a plurality of nozzle holes 113 that eject liquid, for example, ink on the printing medium 3. In this case, a gap (space) between the liquid ejection surface 112 and the platen 102, or a gap (space) between the liquid ejection surface 112 and the printing medium 3 is generally called platen gap.

The ink jet head 111 includes a driving element such as a piezoelectric element for ejecting liquid from each of the nozzle holes 113. Also, an ink cartridge 115 that supplies the ink jet head 111 with ink is mounted on the support member 110.

The ink jet head 111, the ink cartridge 115, and the support member 110 form the head unit 116.

In this embodiment, an example of using a single-color ink cartridge 115 and using ink as the liquid is described. Alternatively, the ink cartridge 115 may be arranged at a location other than the head unit 116.

Also, for example, a flushing area (not illustrated) of the ink jet head 111 is provided below the platen 102. The platen 102 is retractable from a position below the ink jet head 111. While the platen 102 is retracted, by ejecting ink from the nozzle holes 113 of the ink jet head 111, ink increased in viscosity is discharged. A gap between the flushing area and the liquid ejection surface 112 is also called platen gap.

Two plasma actuators 120 are arranged on a surface of the liquid ejection surface 112 of the ink jet head 111 facing the platen 102, on both end portions in the transport direction of the printing medium 3 with the nozzle row 114 interposed therebetween. Each plasma actuator 120 is longer than the nozzle row 114.

The platen gap is typically narrow, and may be occasionally 1 mm or less. Hence, as illustrated in FIG. 27, each plasma actuator 120 has to be arranged on a surface recessed by one step from a surface where the nozzle row 114 is arranged. The recessed surface also corresponds to the liquid ejection surface 112. Alternatively, the plasma actuator 120 may be embedded in the ink jet head 111 and the step may be eliminated, or may be arranged on a surface at a distance larger than the distance between the nozzle row 114 and the platen 102.

The plasma actuator 120 according to this embodiment has a basic structure similar to that of the plasma actuator according to the above-described embodiment illustrated in FIG. 4. By controlling application of an alternating voltage, the plasma actuator 120 can be easily controlled for generation and stop of an airflow, or an airflow rate. This feature is not easily provided by an airflow generating device such as a fan. Alternatively, two electrodes 21b may be prepared and arranged such that an electrode 21a is interposed between the electrodes 21b. Thus, an airflow generation direction can be controlled in forward and reverse directions by selecting one of the two electrodes 21b.

The plasma actuators 120 are arranged to generate airflows in the transport direction of the printing medium 3. In this embodiment, the plasma actuators 120 are configured of two plasma actuators 120 arranged so that airflow generation directions of the plasma actuators 120 are opposite to each other.

With this configuration, an airflow can be generated on one side of the nozzle row 114, to either of both directions in the transport direction of the printing medium 3.

The arrangement of the plasma actuators 120 is not limited thereto, and the airflow generation direction may be desirably determined. The plasma actuators 120 may be arranged on only either of both sides of the nozzle row 114, or may be arranged in a direction intersecting with the nozzle row 114. Hereinafter, various arrangements and various airflow generation directions are exemplified.

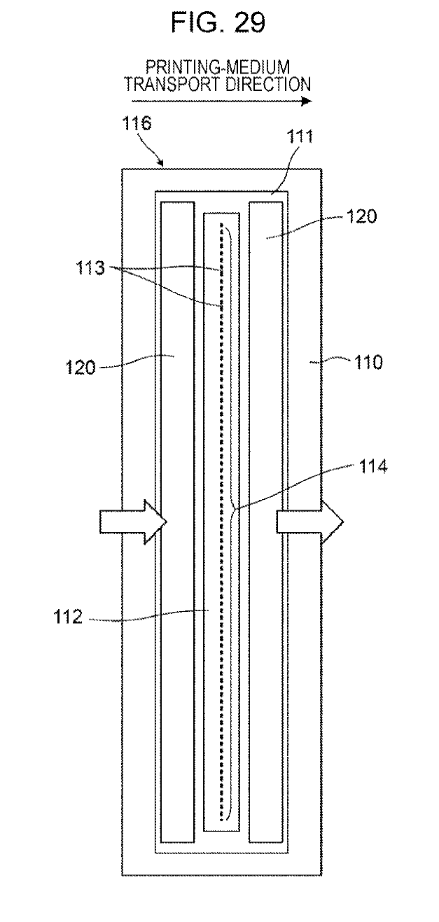

FIG. 29 illustrates an example of generating airflows in the same direction as the transport direction of the printing medium 3 by the driving of the plasma actuators 120.

As illustrated in FIG. 29, the plasma actuators 120 generate airflows in the same direction as the transport direction of the printing medium 3.

By generating the airflows in this way, the air in the platen gap likely moves with the transport of the printing medium 3, and a mist around the liquid ejection surface 112 is discharged. In the head unit 116, a Karman vortex is generated toward the downstream side in the transport direction of the printing medium 3; however, by driving the plasma actuators 120 in this way, the generation of a Karman vortex can be suppressed. Thus, random diffusion of a mist into a casing of the printer 101 due to a Karman vortex can be reduced. Also, since the two plasma actuators 120, 120 generate the airflows in the same direction, strong airflows are generated, and a mist around the liquid ejection surface 112 can be efficiently discharged.

Alternatively, airflows may be generated toward the upstream side in the transport direction of the printing medium 3. Thus, a mist around the liquid ejection surface 112 can be discharged when the printing medium 3 decelerates for stop. When the printing medium 3 is cut paper, the printing medium 3 is less likely contaminated with the mist.

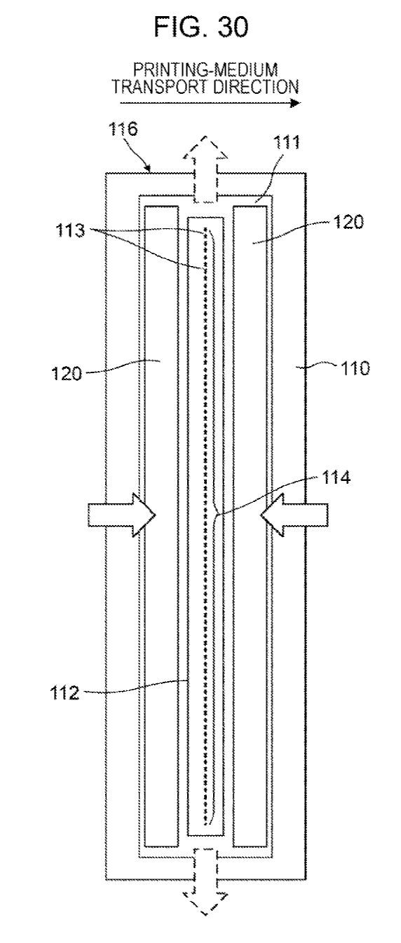

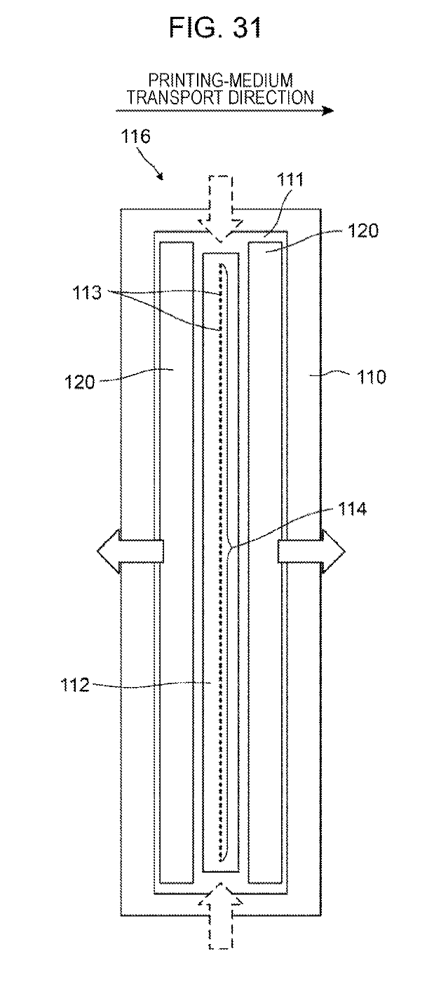

FIG. 30 illustrates an example of generating airflows toward the nozzle row 114 by the driving of the plasma actuators 120. FIG. 31 illustrates an example of generating airflows away from the nozzle row 114 by the driving of the plasma actuators 120.

As illustrated in FIG. 30, since the plasma actuators 120 generate the airflows toward the nozzle row 114, as indicated by broken-line arrows in FIG. 30, a mist can be discharged in a direction orthogonal to the transport direction of the printing medium 3. Thus, the printing medium 3 is not contaminated with the discharged mist.

Also, as illustrated in FIG. 31, since the plasma actuators 120 generate the airflows away from the nozzle row 114, as indicated by broken-line arrows in FIG. 31, airflows enter in the direction orthogonal to the transport direction of the printing medium 3, and a mist can be discharged in both the directions away from the nozzle row 114. Thus, the discharged mist does not unevenly stay in a specific location in the printer 101.

The plasma actuators 120 may be driven while the printing medium 3 is transported, or may be driven while the printing medium 3 is not transported.

Regarding the plasma actuators 120, only one of the plasma actuators 120 may be driven. Hereinafter, an example of the head unit 116 including plasma actuators 120a and 120b is described.

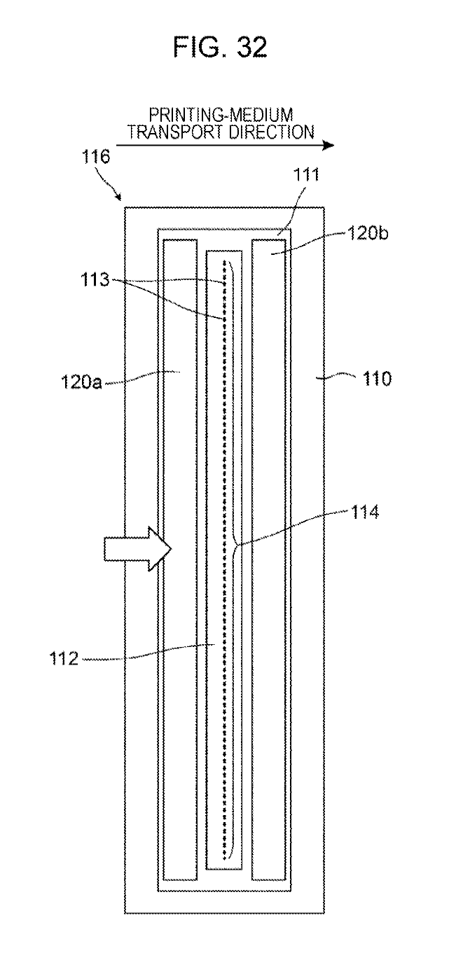

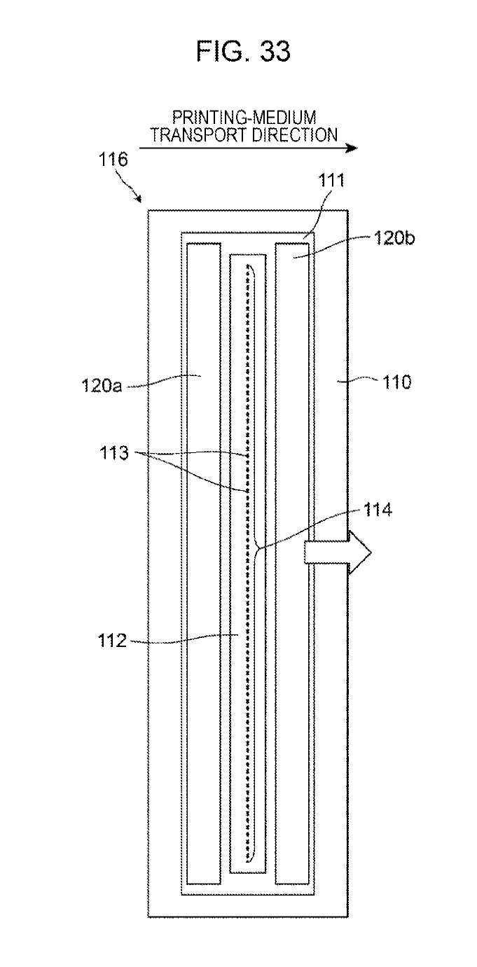

FIGS. 32 and 33 illustrate examples of driving only one of the plasma actuators 120 (120a, 120b).

As illustrated in FIG. 32, when only the plasma actuator 120a located on the upstream side in the transport direction of the printing medium 3 is driven, the plasma actuator 120a generates an airflow toward the nozzle row 114.

As illustrated in FIG. 33, when only the plasma actuator 120b located on the downstream side in the transport direction of the printing medium 3 is driven, the plasma actuator 120b generates an airflow away from the nozzle row 114. In the cases, only the plasma actuator 120 to be driven may be mounted and the plasma actuator 120 not to be driven may be omitted.

By driving the plasma actuators 120 in this way, strong airflows can be generated in the same direction as the transport direction of the printing medium 3, and hence a mist in the head gap can be efficiently discharged. Also, an airflow may be generated in a direction opposite to the transport direction of the printing medium 3.

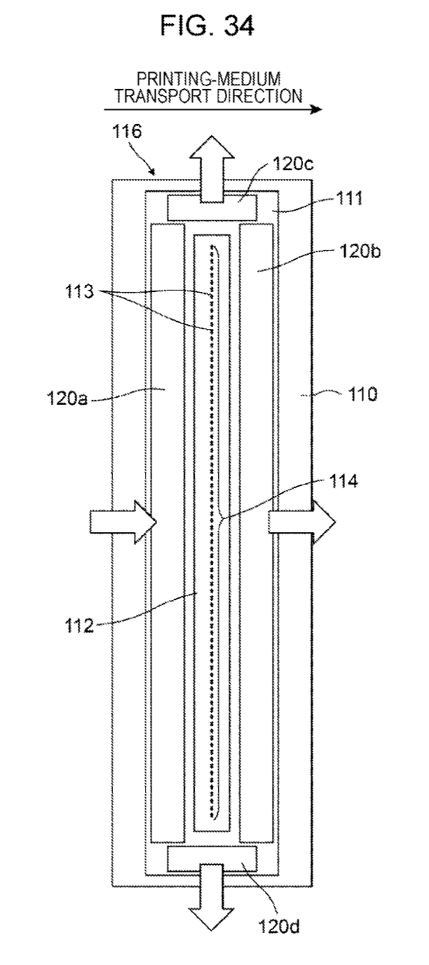

FIGS. 34 to 37 illustrate modifications in which plasma actuators 120 are arranged also in a direction intersecting with the transport direction of the printing medium 3.

As illustrated in FIG. 34, the plasma actuators 120a and 120b generate airflows in the same direction, and plasma actuators 120c and 120d arranged in the intersection direction generate airflows away from the nozzle row 114.

By driving the plasma actuators 120 in this way, a mist present in a portion of the platen gap can be evenly and efficiently discharged. Also, since a mist is discharged in three directions, the discharged mist does not unevenly stay in a specific location in the printer.

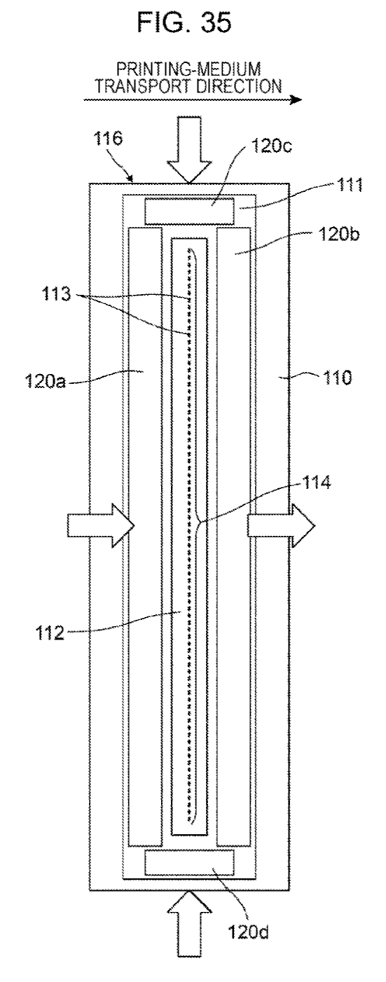

Also, as illustrated in FIG. 35, the plasma actuators 120a and 120b on both end portions in the transport direction of the printing medium 3 generate airflows in the same direction, and the plasma actuators 120c and 120d arranged in the intersection direction generate airflows toward the nozzle row 114.

By driving the plasma actuators 120 in this way, strong airflows can be generated, and hence a mist in the platen gap can be efficiently discharged.

Alternatively, in the examples of FIGS. 34 and 35, the plasma actuators 120a and 120b may generate airflows in a direction opposite to the transport direction of the printing medium 3.

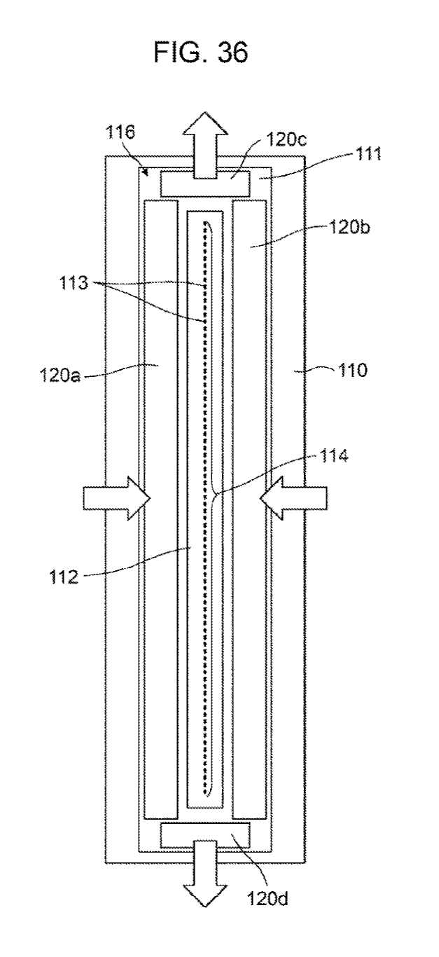

Also, as illustrated in FIG. 36, the plasma actuators 120a and 120b generate airflows toward the nozzle row 114, and the plasma actuators 120c and 120d arranged in the intersection direction generate airflows away from the nozzle row 114.

By driving the plasma actuators 120 in this way, a mist in the head gap can be efficiently discharged in the direction intersecting with the transport direction of the printing medium 3, and hence the printing medium 3 is not contaminated with the discharged mist.

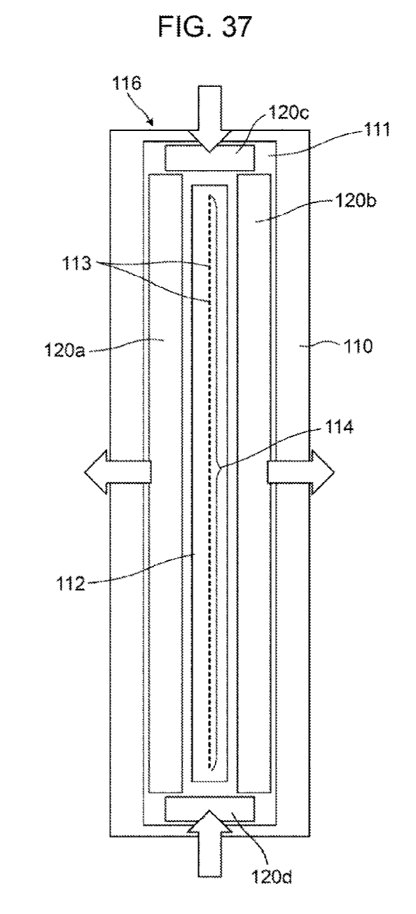

Also, as illustrated in FIG. 37, the plasma actuators 120a and 120b generate airflows away from the nozzle row 114, and the plasma actuators 120c and 120d arranged in the intersection direction generate airflows toward the nozzle row 114.

By driving the plasma actuators 120 in this way, airflows enter in a direction orthogonal to the transport direction of the printing medium 3, and hence, a mist in the head gap can be discharged in both the directions away from the nozzle row 114. Thus, the discharged mist does not unevenly stay in a specific location in the printer.

Alternatively, the plasma actuators 120 may be arranged only in the direction intersecting with the transport direction of the printing medium 3.

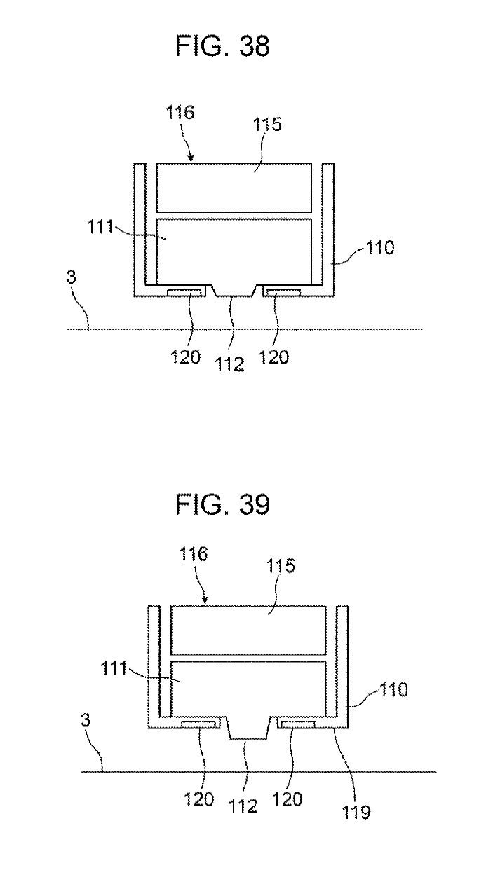

FIG. 38 illustrates an example in which the plasma actuators 120 are mounted on the support member 110. As illustrated in FIG. 38, the plasma actuators 120 are mounted on the support member 110 such that the plasma actuators 120 are embedded in the support member 110. Thus, since the plasma actuators 120 are not mounted on the ink jet head 111, the ink jet head 111 can be simply configured, and easily manufactured.

FIG. 39 illustrates a modification of an arrangement structure of the plasma actuators 120. As illustrated in FIG. 39, step surfaces 119 may be formed at the support member 110 at positions farther from the printing medium 3 than the liquid ejection surface of the ink jet head 111, and the plasma actuators 120 may be arranged on the step surfaces 119. Even when the plasma actuators 120 are arranged on the ink jet head 111 as illustrated in FIG. 27, step surfaces may be likewise formed at the ink jet head 111.

Thus, the distance between the plasma actuators 120 and the platen 102 or the printing medium 3 is larger than the platen gap, and a mist can be efficiently discharged. Even in the cases of FIGS. 38 and 39, the surfaces on which the plasma actuators 120 are arranged can be called the liquid ejection surface 112.

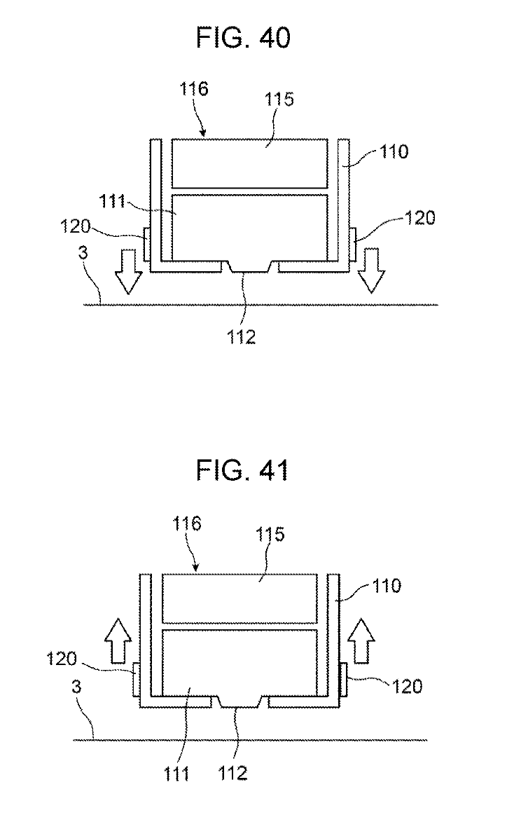

FIGS. 40 and 41 illustrate modifications of arrangements of the plasma actuators 120.

The plasma actuators 120 are arranged on side surfaces of the support member 110.

FIG. 40 illustrates an example in which the plasma actuators 120 generate airflows downward, that is, toward the printing medium 3.

As illustrated in FIG. 40, since the plasma actuators 120 generate the airflows toward the printing medium 3, a mist in the platen gap lands on the printing medium 3 through the generated downward airflows, and the mist does not adhere to the liquid ejection surface 112.

FIG. 41 illustrates an example in which the plasma actuators 120 generate airflows upward, that is, away from the printing medium 3.

As illustrated in FIG. 41, since the plasma actuators 120 generate the airflows away from the printing medium 3, a mist staying around the liquid ejection surface 112 can be moved away from the liquid ejection surface 112. Alternatively, in the examples of FIGS. 40 and 41, the plasma actuators 120 may be mounted on the ink jet head 111.

A control configuration of this embodiment is described next.

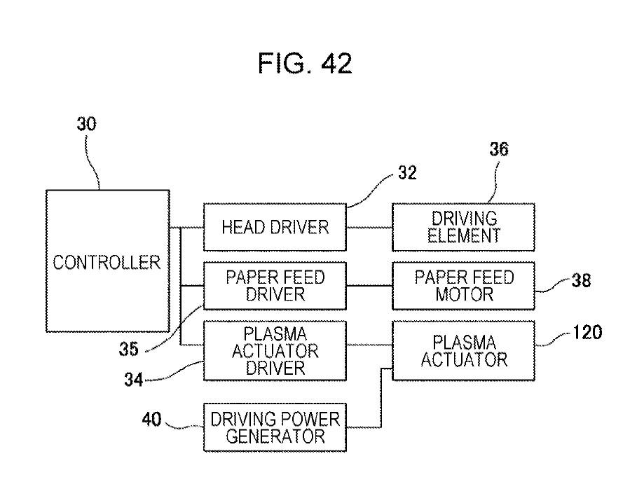

FIG. 42 is a block diagram illustrating a functional configuration of the printer 101 according to this embodiment.

As illustrated in FIG. 42, the printer 101 includes a controller 30 that controls respective devices, and various driver circuits that drive various motors and so forth under the control of the controller 30 and output a detection state of a detection circuit to the controller 30. The various driver circuits include a head driver 32, a plasma actuator driver 34, and a paper feed driver 35.

The controller 30 centrally controls the respective devices of the printer 101. The controller 30 includes, for example, a CPU, a ROM that stores an executable basic control program and data relating to the basic control program in a non-volatile manner, a RAM that temporarily stores a program to be executed by the CPU and predetermined data, and other peripheral circuits.

The head driver 32 is coupled to a driving element 36 such as a piezoelectric element for ejecting ink. The driving element 36 is driven under the control of the controller 30, and causes ink to be ejected from the nozzle hole 113 by a required amount.

The plasma actuator driver 34 is coupled to each plasma actuator 120, and outputs a driving signal to the plasma actuator 120 to drive the plasma actuator 120 through the controller 30.

The paper feed driver 35 is coupled to a paper feed motor 38, and outputs a driving signal to the paper feed motor 38 to operate the paper feed motor 38 by an amount instructed by the controller 30. The printing medium 3 is transported in the transport direction by a predetermined amount in accordance with the operation of the paper feed motor 38.

To drive each plasma actuator 120, a high voltage is required. The printer 101 includes a driving voltage generator 40 that generates a driving voltage for driving the plasma actuator 120. The driving voltage generator 40 is coupled to the plasma actuator 120 and the plasma actuator driver 34.

Note that a flexible cable that transmits a head driving signal is arranged on the head unit 116. It is not desirable to additionally arrange high-voltage wiring for driving the plasma actuator 120 in the flexible cable because a problem may arise in distance for insulation, countermeasure for short-circuit, and countermeasure for noise.

Owing to this, in this embodiment, a low-voltage power supply line is arranged in the flexible cable, and the driving voltage generator 40 is mounted on the head unit 116. The driving voltage generator 40 uses its low-voltage power as an input voltage, and raises the input voltage to a high voltage in the head unit 116.

When a piezoelectric element is used for the driving element 36, since the power supply line for driving the piezoelectric element is arranged in the flexible cable, a power for driving the piezoelectric element may be used as an input voltage to the driving voltage generator 40. Also when a thermal-type driving element is used for the driving element 36, a power for driving the thermal head may be used as an input voltage to the driving voltage generator 40 likewise. Of course, an independent low-voltage power line may be arranged in a circuit board 141.

Note that, unless a problem arises in distance for insulation, countermeasure for short-circuit, and countermeasure for noise, high-voltage wiring for driving the plasma actuator 120 may be arranged in the flexible cable, or another cable for high-voltage wiring different from the flexible cable for transmitting the head driving signal may be arranged.

Similarly to the above-described embodiment, the controller 30 controls driving of the plasma actuator 120 via the plasma actuator driver 34.

As illustrated in FIG. 21, for example, in comparison to a timing at which the driving element 36 of the ink jet head 111 is driven and ink is ejected, the controller 30 performs control to start the driving of the plasma actuator 120 earlier than the ejection start of ink. Also, the controller 30 performs control to end the driving of the plasma actuator 20 later than the ejection end of ink.

By driving the plasma actuator 120 earlier than the ejection start of ink, a mist staying before ink ejection can be discharged, and a mist just after the ejection start of ink can be discharged. By ending the driving of the plasma actuator 120 later than the ejection end of ink, a mist staying during printing can be discharged.

Also, the controller 30 may perform control to drive the plasma actuator 120 to generate airflows when ink is not ejected from the ink jet head 111. That is, the controller 30 performs control not to drive the plasma actuator 120 when ink is ejected from the ink jet head 111.

With this control, for example, when high ink-landing precision is demanded in such a case of printing in a high-precision printing mode, the ink-landing precision can be further increased.

In some cases, ink is not ejected, for example, when the printing medium 3 is transported to a printing position or when flushing is performed in the flushing area. A mist may be discharged by driving the plasma actuator 120 in this case.

In particular, mists are more generated during the flushing operation when the adjacent nozzle rows are simultaneously driven. In related art, the flushing operation has been executed while the adjacent nozzle rows are not simultaneously driven. By driving the plasma actuator 120 during the flushing operation, a mist can be efficiently discharged. Flushing can be executed simultaneously for the entire nozzle row 114, and throughput can be increased.

While the plasma actuators 120 are arranged on the single ink jet head 111 according to this embodiment, the invention is not limited thereto.

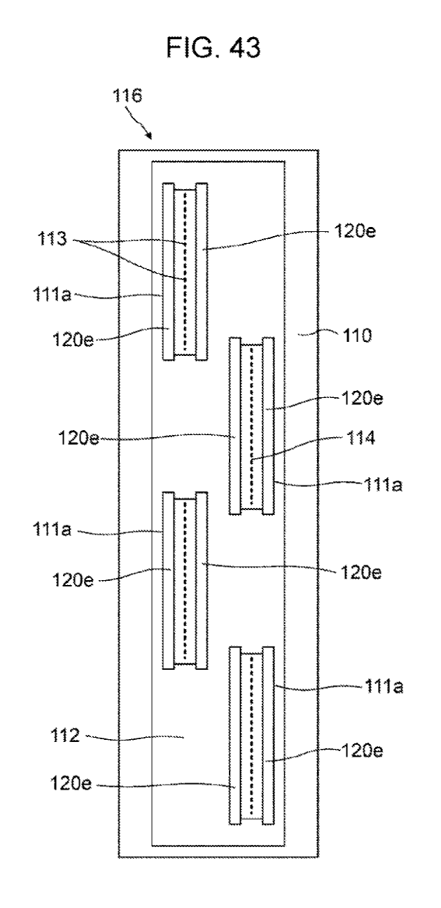

FIG. 43 illustrates an example in which an ink jet head is configured of a plurality of unit ink jet heads 111a. As illustrated in FIG. 43, the unit ink jet heads 111a may be arranged in a staggered manner, and plasma actuators 120e may be arranged individually for the unit ink jet heads 111a.

In this case, among the unit ink jet heads 111a, a unit ink jet head 111a that ejects ink from the nozzle row 114 and a unit ink jet head 111a that does not eject ink from the nozzle row 114 may be present. In this case, only a plasma actuator 120e corresponding to the unit ink jet head 111a that ejects ink may be driven. Alternatively, the plasma actuators 120 may not be arranged individually for the unit ink jet heads 111a.

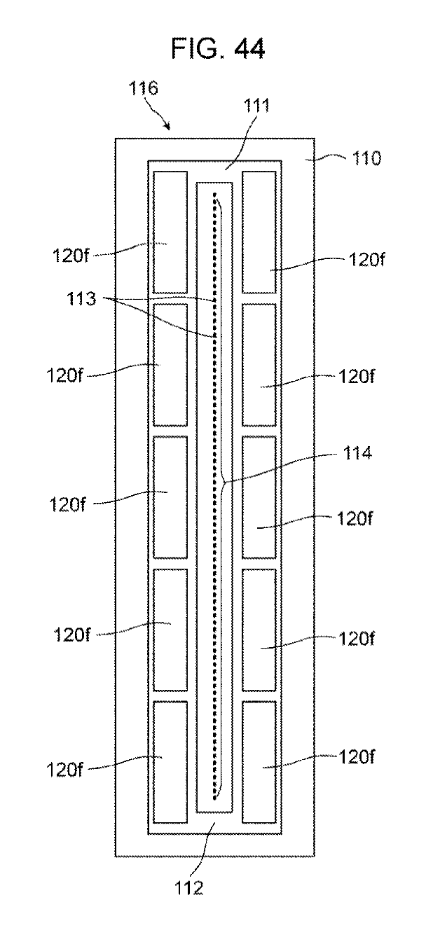

FIG. 44 illustrates an example in which the plasma actuators 120 are a plurality of plasma actuators 120f arranged in lines. As illustrated in FIG. 44, even when the plurality of plasma actuators 120f are arranged in lines, similar advantages can be attained.

Also, in this case, in the ink jet head 111, the nozzle row 114 may include a nozzle hole 113 that ejects ink and a nozzle hole 113 that does not eject ink. In this case, only a plasma actuator 120f corresponding to the nozzle hole 113 that ejects ink may be driven.

Also, the plasma actuators 120 may be formed as a unit, and the unit may be arranged in a manner attachable to and detachable from the ink jet head 111 or the support member 110.

A printing method of this embodiment is described next.

When the printer 101 performs printing, the controller 30 performs control on the head driver 32 and the paper feed driver 35. Thus, by driving the driving element 36 while driving the paper feed motor 38 to transport the printing medium 3 in the transport direction, ink is ejected from the nozzle holes 113, and thus printing is performed on the printing medium 3.

In this case, the controller 30 outputs a driving signal to the plasma actuator 120, and causes the plasma actuator 120 to be driven. The plasma actuator 120 may be driven in any of the above-described ways.

Accordingly, since the airflow is generated by driving the plasma actuator 120, the air in the platen gap likely moves, and a mist around the liquid ejection surface 112 can be discharged.

Alternatively, the printer 101 according to this embodiment may include a plurality of head units 116 for performing color printing. In this case, the above-described configuration is applied to each head unit 116, and hence a mist of each head unit 116 around the liquid ejection surface 112 can be discharged.

As described above, the printer 101 according to the embodiment to which the invention is applied includes the head unit 116 including the linear ink jet head 111 that ejects liquid from the nozzle row 114 being open in the liquid ejection surface 112 arranged on the surface facing the printing medium 3. The printer 101 also includes the paper feed motor 38 (printing-medium transport portion) that transports the printing medium 3, and the plasma actuator 120 that generates an airflow with respect to the platen gap. The printer 101 also includes the controller 30 that controls liquid ejection from the nozzle row 114, airflow generation of the plasma actuator 120, and transport of the printing medium 3 by the paper feed motor 38.

Accordingly, since the airflow is generated by driving the plasma actuator 120, the air in the platen gap likely moves, and a mist around the liquid ejection surface 112 can be discharged. Thus, a mist unlikely adheres to the liquid ejection surface 112, and occurrence of a misprint can be reduced. Also, since the plasma actuator 120 is provided, a large-scale airflow generating device is not additionally required, and facilitation cost can be reduced.

In an example of this embodiment, the plasma actuator 120 may be arranged on the liquid ejection surface 112.

Accordingly, a mist around the liquid ejection surface 112 can be efficiently discharged.

In an example of this embodiment, the plasma actuator 120 may be arranged beside the nozzle row 114.

Accordingly, an airflow can be generated in the transport direction of the printing medium 3, and a mist can be discharged in the same direction as the transport direction of the printing medium 3 or the direction opposite thereto.

In an example of this embodiment, the plasma actuator 120 may be arranged on the support member 110 of the ink jet head 111.

Accordingly, by driving the plasma actuator 120, an airflow can be generated at the support member 110, and hence a mist around the liquid ejection surface 112 can be discharged.

In an example of this embodiment, the plasma actuator 120 may be arranged at a position at a distance larger than the distance between the liquid ejection surface 112 and the printing medium 3.

Accordingly, an airflow can be generated at a position separated from the liquid ejection surface 112, and a mist can be discharged by the airflow.

In an example of this embodiment, the plasma actuator 120 may be arranged on a surface intersecting with the liquid ejection surface 112.

Accordingly, by driving the plasma actuator 120, an airflow can be generated toward or away from the printing medium 3, and a mist can be discharged by the airflow.

In an example of this embodiment, an airflow generation region due to the plasma actuator 120 may be longer than the nozzle row 114.

Accordingly, the airflow generation region due to the plasma actuator 120 can be ensured in a region longer than the nozzle row 114, and a mist generated from the nozzle row 114 can be reliably discharged.

In an example of this embodiment, the linear ink jet head may be configured such that a plurality of unit ink jet heads 111a are arranged in a staggered manner.

Accordingly, even when the linear ink jet head is configured such that the unit ink jet heads 111a are arranged in a staggered manner, a mist of each unit ink jet head 111a around the liquid ejection surface 112 can be discharged.

In an example of this embodiment, the plasma actuator 120 may be arranged for each of the unit ink jet heads 111a.

Accordingly, since the plasma actuator 120 can be driven for each unit ink jet head 111a, a mist of each unit ink jet head 111a around the liquid ejection surface 112 can be reliably discharged.

In an example of this embodiment, the plasma actuator 120 may be arranged such that a plurality of plasma actuators 120f are lined.

Accordingly, since the plurality of plasma actuators 120f are arranged, the plasma actuator 120f corresponding to the nozzle hole 113 that ejects ink can be driven.

In an example of this embodiment, the controller 30 may drive the plasma actuator 120 to generate an airflow so that a mist which is generated when liquid is ejected from the nozzle row 114 (and which floats around without arriving at the printing medium) does not stay around the liquid ejection surface 112.

Accordingly, since the airflow is generated by driving the plasma actuator 120, the air in the platen gap likely moves, and a mist around the liquid ejection surface 112 can be discharged. Thus, a mist unlikely adheres to the liquid ejection surface 112, and occurrence of a misprint can be reduced.

In an example of this embodiment, the controller 30 may cause an airflow to be generated in the same direction as the transport direction of the printing medium 3 or in the direction opposite thereto by controlling the driving of the plasma actuator 120.

Accordingly, by generating an airflow in the same direction as the transport direction of the printing medium 3 or the direction opposite thereto, a mist can be efficiently discharged.

In an example of this embodiment, the controller 30 may drive the plasma actuator 120 to generate an airflow when liquid is not ejected from the nozzle row 114.

Accordingly, since the airflow is generated while liquid is not ejected, for example, when high ink-landing precision is demanded such as a case of printing in a high-precision printing mode, the ink-landing precision can be further increased.

In an example of this embodiment, the controller 30 may not drive the plasma actuator 120 when liquid is ejected from the nozzle row 114 for printing.

Accordingly, since the airflow is not generated while liquid is ejected, for example, when high ink-landing precision is demanded such as a case of printing in a high-precision printing mode, the ink-landing precision can be further increased.

In an example of this embodiment, the controller 30 may drive the plasma actuator 120 to generate an airflow during a flushing operation.

A mist is generated during ink ejection by the flushing operation, and hence the ejection amount of ink has been restricted to reduce the amount of mist. With this configuration, by driving the plasma actuator 120 during the flushing operation, a mist can be discharged. Thus, the restriction is eased, for example, flushing can be executed simultaneously for the entire nozzle row 114, and throughput can be increased.

In an example of this embodiment, the driving voltage generator 40 that generates a driving voltage for driving the plasma actuator 120 is further provided. The driving voltage generator 40 may be mounted on the head unit 116.

Accordingly, the driving voltage for the plasma actuator 120 that is driven with a high voltage can be generated by the driving voltage generator 40. Thus, high voltage wiring is not required to be arranged in the flexible cable or the like, and a problem does not arise in insulation, countermeasure for short-circuit, and countermeasure for noise.

In an example of this embodiment, the head unit 116 includes wiring for supplying an ink jet driving voltage for driving the ink jet head 111, and the driving voltage generator 40 may generate a voltage for driving the plasma actuator 120 by using the ink jet driving voltage.

Accordingly, since the voltage for driving the plasma actuator 120 is generated by using the ink jet driving voltage supplied from the wiring, wiring dedicated for the plasma actuator 120 is not required to be arranged in the flexible cable.

In an example of this embodiment, the plasma actuator 120 may be attachable and detachable.

Accordingly, the plasma actuator 120 can be easily exchanged when the plasma actuator 120 is contaminated with a mist or broken.

### Fourth Embodiment

A forth embodiment of the invention is described next.

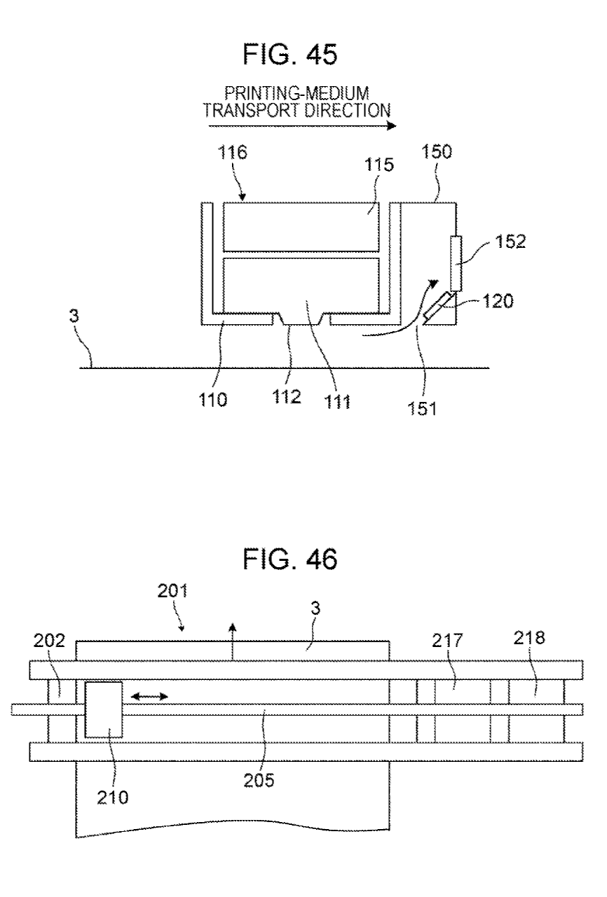

FIG. 45 is a schematic illustration of a head unit 116 according to the fourth embodiment of the invention. Note that the same reference sings are applied to the same portions as those of the third embodiment, and the description thereof is omitted.

As illustrated in FIG. 45, a mist recovery container 150 is provided at the support member 110 in the transport direction of the printing medium 3. The mist recovery container 150 has an opening 151 near the liquid ejection surface 112 of the ink jet head 111.

A plasma actuator 120 that generates an airflow to recover a mist from the opening 151 is arranged in the mist recovery container 150. A filter 152 that recovers the mist sent into the mist recovery container 150 is arranged on a side surface of the mist recovery container 150.

The filter 152 is attachable and detachable. Alternatively, the inside of the mist recovery container 150 may be entirely filled with the filter 152 of, for example, sponge.

By driving the plasma actuator 120 in this embodiment, an airflow from the opening 151 toward the filter 152 is generated in the mist recovery container 150 as indicated by an arrow in the drawing. With this airflow, a mist around the liquid ejection surface 112 enters the mist recovery container 150 from the opening 151, and is recovered by the filter 152.

As described above, in this embodiment, the filter 152 that recovers a mist is provided in a downstream portion of the airflow generated by the plasma actuator 120, and the filter 152 is attachable and detachable.

Accordingly, by driving the plasma actuator 120, a mist generated from the nozzle row 114 can be recovered by the filter 152. Also, since the filter 152 is attachable and detachable, the filter 152 can be easily exchanged, for example, when the filter 152 is contaminated.

While the filter 152 is attachable and detachable in the fourth embodiment, the invention is not limited thereto. For example, the mist recovery container 150 may be entirely exchanged instead of exchanging only the filter 152.

### Fifth Embodiment

A fifth embodiment of the invention is described next.

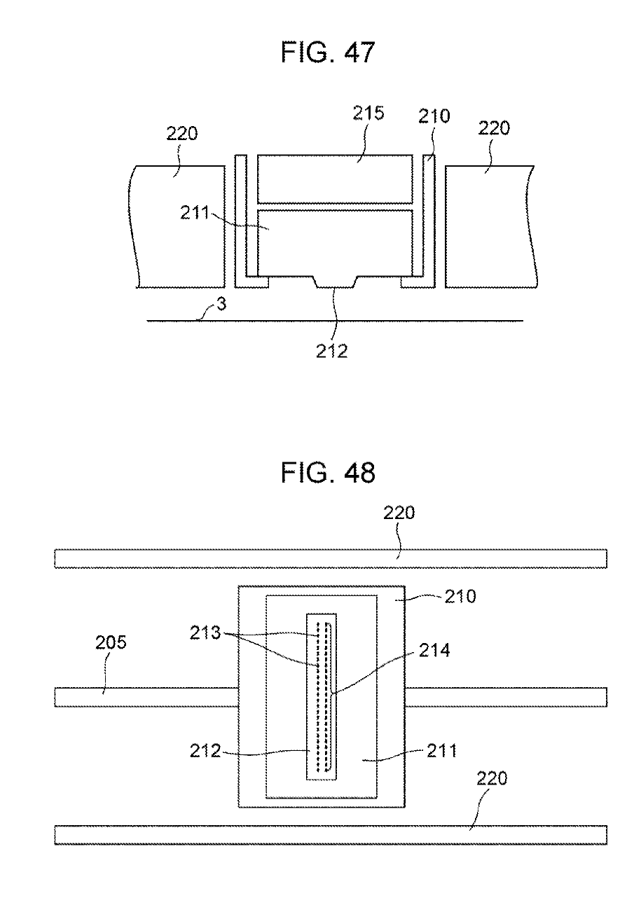

FIG. 46 is a schematic illustration of a printer according to the fifth embodiment. FIG. 47 is a schematic illustration of an ink jet head of the printer according to the fifth embodiment. FIG. 48 is a schematic illustration when viewed from a liquid ejection surface in FIG. 47. Described in the fifth embodiment is a case where a serial-type ink jet head mounted on a carriage that reciprocates in a main-scanning direction is used as an ink jet head.

As illustrated in FIG. 46, a printer 201 includes a flat-plate-shaped platen 202. A predetermined printing medium 3 is transported on an upper surface of the platen 202 in a sub-scanning direction by a paper feed mechanism (not illustrated). The platen 202 may be provided with an ink discarding region for no-margin printing.

The printing medium 3 is similar to that of the above-described embodiment and hence the description is omitted.

A guide shaft 205 that extends in a direction orthogonal to a transport direction of the printing medium 3 is provided above the platen 202. A carriage 210 is provided on the guide shaft 205 so that the carriage 210 can be driven to reciprocate along the guide shaft 205 via a driving mechanism (not illustrated).

An ink jet head 211 is mounted on the carriage 210. A surface of an ink jet head 211 facing the platen 202 is a liquid ejection surface 212. The liquid ejection surface 212 has a nozzle row 214 being open in the liquid ejection surface 212. The nozzle row 214 includes a plurality of nozzle holes 213 that eject liquid, for example, ink on the printing medium 3. In this embodiment, the nozzle row 214 includes two nozzle rows 214 formed in parallel to each other. In this case, a gap between the liquid ejection surface 212 and the platen 202, or a gap between the liquid ejection surface 212 and the printing medium 3 is generally called platen gap. An example of using ink as the liquid is described below.

The ink jet head 211 includes a driving element such as a piezoelectric element for ejecting liquid from each of the nozzle holes 213. Also, an ink cartridge 215 that supplies the ink jet head 211 with ink is mounted on the carriage 210.

The carriage 210, the ink jet head 211, and the ink cartridge 215 are collectively called ink jet head. In this embodiment, an example of using a single-color ink cartridge 215 is described. Alternatively, the ink cartridge 215 may be arranged at a location other than the carriage 210.

A flushing area 217 of the ink jet head 211 is provided on one side of the platen 202. By ejecting ink from the nozzle holes 213 of the ink jet head 211 to the flushing area 217, ink increased in viscosity is discharged. A gap between the flushing area 217 and the liquid ejection surface 212 is also called platen gap.

A cleaning area 218 including a cap (not illustrated) is provided on one side of the flushing area 217. By ejecting ink in the cleaning area 218 while the cap is attached so as to cover the nozzle rows 214 of the ink jet head 211, the nozzle holes 213 are cleaned.

Two plasma actuators 220 extending along the guide shaft 205 are arranged on both sides of the guide shaft 205 in a transport direction of the printing medium 3 with the ink jet head 211 interposed therebetween.

The plasma actuators 220 extend in a movement direction of the ink jet head 211, and are arranged in a movable range of at least the ink jet head 211.

Each plasma actuator 220 according to this embodiment has a basic structure similar to that of the plasma actuator according to the above-described embodiment illustrated in FIG. 4.

Hence, by adjusting the arrangement of two electrodes 21a and 21b, an airflow can be generated in a desirable direction. By controlling application of an alternating voltage, the plasma actuator 220 can be easily controlled for generation and stop of an airflow, or an airflow rate. This feature is not easily provided by an airflow generating device such as a fan. Alternatively, two electrodes 21b may be prepared and arranged such that an electrode 21a is interposed between the electrodes 21b. Thus, an airflow generation direction can be controlled in forward and reverse directions by selecting one of the two electrodes 21b. Alternatively, two electrodes 21a may be prepared and arranged such that an electrode 21b is interposed between the electrodes 21a. By simultaneously driving the two electrodes 21a, airflows generated by the two plasma actuators collide with each other at the electrode 21b, and generate airflows in a direction intersecting with the surface where the electrodes are arranged.

The plasma actuators 220 are arranged to generate airflows in the movement direction of the ink jet head 211. The plasma actuators 220 are configured of, for example, a plurality of plasma actuators 220 alternately arranged so that airflow generation directions of the plasma actuators 220 are opposite to each other.

With this configuration, an airflow can be generated on both sides of the ink jet head 211, to either of both directions in the movement direction of the ink jet head 211.

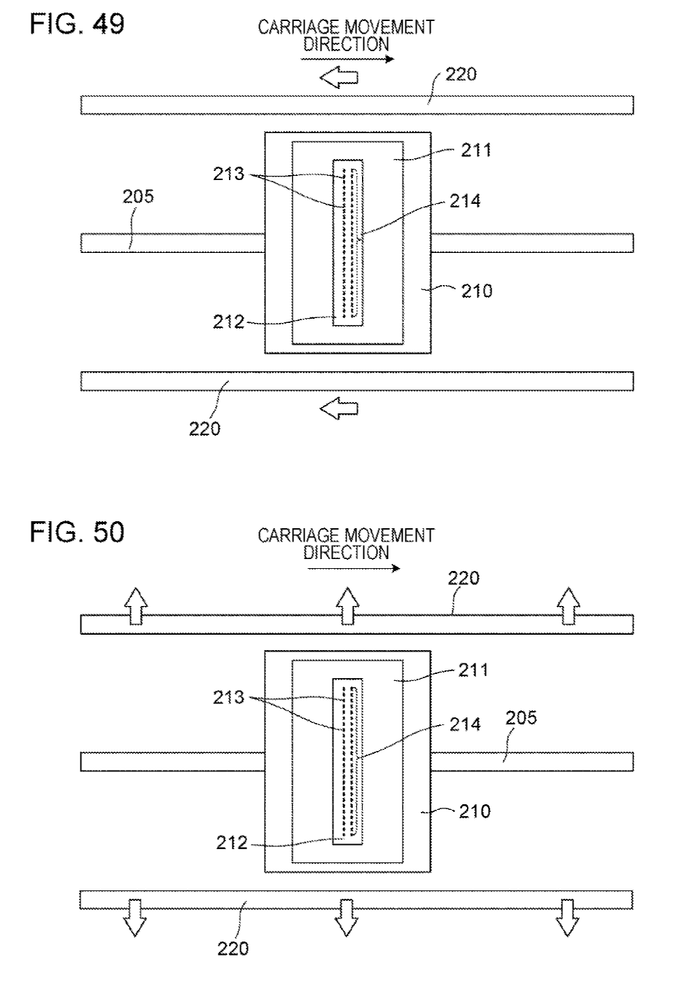

FIG. 49 illustrates an example of generating airflows in a direction opposite to the movement direction of the ink jet head 211 by the driving of the plasma actuators 220.

As illustrated in FIG. 49, when the carriage 210 with the ink jet head 211 mounted moves in the movement direction, the plasma actuators 220 generate airflows in the direction opposite to the movement direction of the ink jet head 211.

By generating the airflows in this way, the air in the platen gap likely moves with the movement of the carriage 210, and a mist around the liquid ejection surface 212 is discharged. A Karman vortex is generated in the rear of the carriage 210 in the movement direction; however, by driving the plasma actuators 220 in this way, the generation of a Karman vortex can be suppressed. Thus, random diffusion of a mist into a casing of the printer 201 due to a Karman vortex can be reduced.

FIG. 49 illustrates an example when the ink jet head 211 moves rightward in the drawing; however, when the ink jet head 211 moves in the opposite direction, the plasma actuators 220 also reverse the direction of airflows.

FIG. 50 illustrates an example of generating airflows in a direction intersecting with the movement direction of the ink jet head by the driving of the plasma actuators 220.

As illustrated in FIG. 50, when the carriage 210 with the ink jet head 211 mounted moves in the movement direction, the plasma actuators 220 generate airflows away from the ink jet head 211.

By generating the airflows in this way, the air in the platen gap likely moves with the movement of the carriage 210, and a mist around the liquid ejection surface 212 is discharged in a direction orthogonal to the movement direction of the carriage 210.

Alternatively, airflows toward the carriage 210 may be generated by driving the plasma actuators 220 in the reverse manner to FIG. 50.

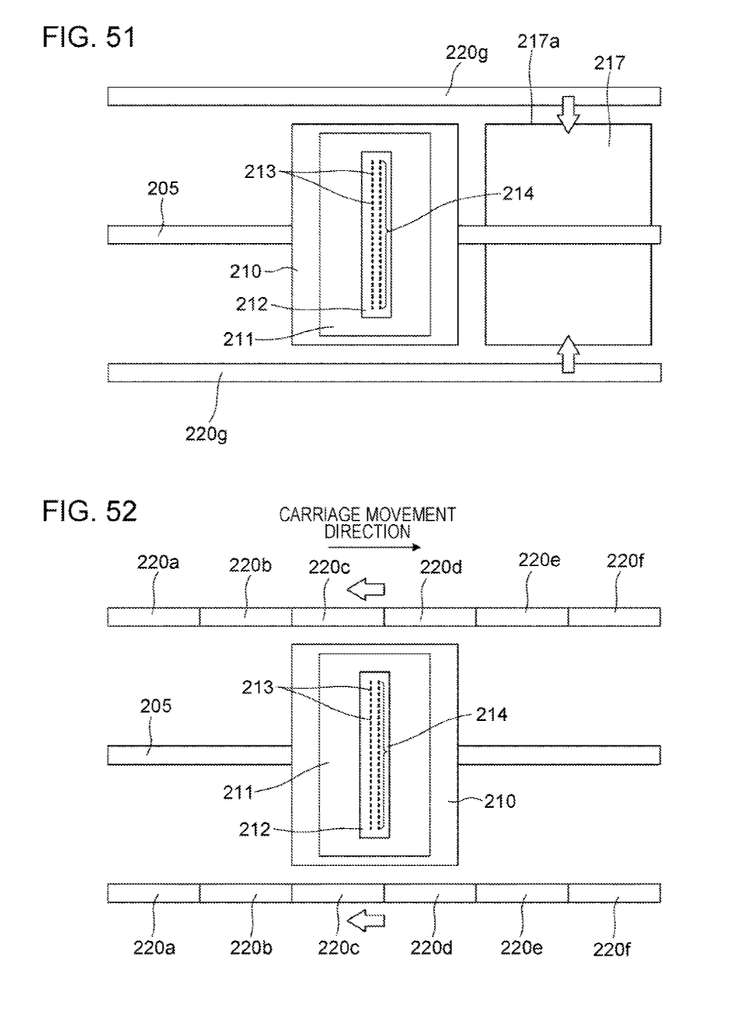

FIG. 51 illustrates an example of generating airflows in the flushing area.

As illustrated in FIG. 51, when the ink jet head 211 moves to the flushing area 217 and performs flushing, flushing-area plasma actuators 220g are driven to generate airflows toward an ink recovery box 217a of the flushing area 217.

Mists are more generated during the flushing operation when the adjacent nozzle rows 214 are simultaneously driven. In related art, the flushing operation has been executed while the adjacent nozzle rows are not simultaneously driven. In this embodiment, by driving the flushing-area plasma actuators 220g during the flushing operation, a mist is recovered by using the airflows toward the ink recovery box 17a. Flushing can be executed simultaneously for all nozzle rows 214, and throughput can be increased.

Alternatively, the flushing-area plasma actuators 220g may generate airflows in a direction perpendicular to the paper face of FIG. 51.

FIG. 52 illustrates an example in which each plasma actuator 220 is configured of a plurality of unit plasma actuators 220a to 220f arranged in line.

As illustrated in FIG. 52, the unit plasma actuators 220a to 220f generate airflows in a direction opposite to the movement direction of the carriage 210.

By generating the airflows in this way, the air in the platen gap likely moves with the movement of the carriage 210, and a mist around the liquid ejection surface 212 is discharged.

Also, by arranging the plurality of unit plasma actuators 220a to 220f in line, the unit plasma actuators 220a to 220f can be selectively driven in accordance with the movement of the carriage 210.

For example, when the carriage 210 moves in the movement direction of the carriage 210, in FIG. 52, the unit plasma actuator 220e located directly in front of the ink jet head 211 in the movement direction of the carriage 210 may be driven. When the carriage 210 moves in the direction opposite to the movement direction, the unit plasma actuator 220b located directly behind the ink jet head 211 may be driven.

A mist likely stays in the direction opposite to the movement direction of the ink jet head 211. Thus, the driving of the plasma actuators 220 may be increased, and the flow amount may be increased.

Also, the plasma actuators 220 may be formed as a unit, and the unit may be arranged in an attachable and detachable manner.

A control configuration of this embodiment is described next.

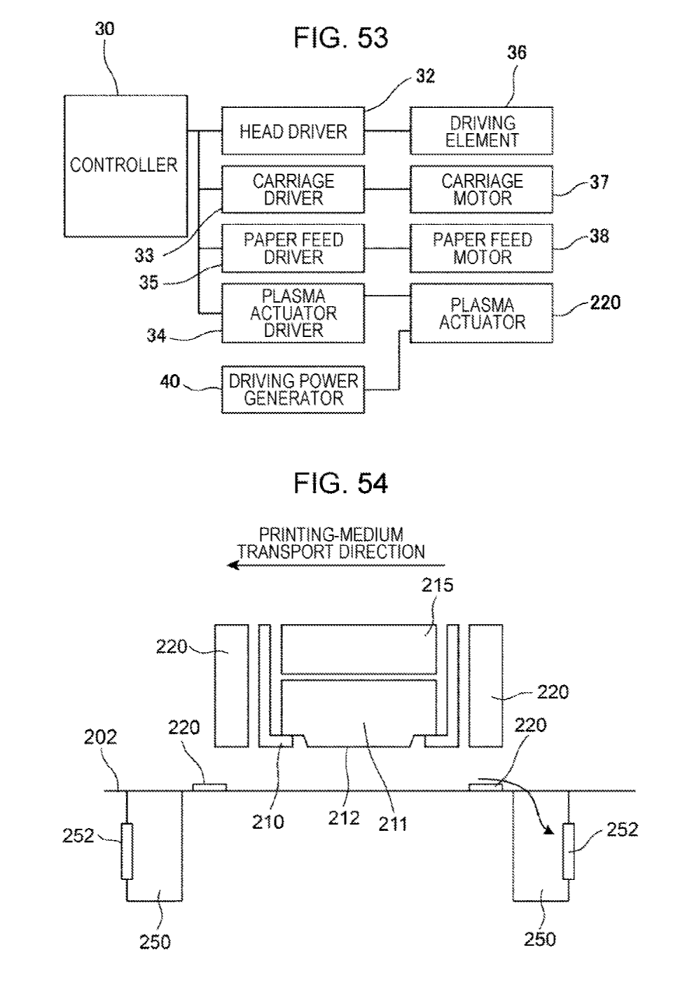

FIG. 53 is a block diagram illustrating a functional configuration of the printer 201 according to this embodiment.

As illustrated in FIG. 53, the printer 201 includes a controller 30 that controls respective devices, and various driver circuits that drive various motors and so forth under the control of the controller 30 and output a detection state of a detection circuit to the controller 30. The various driver circuits include a head driver 32, a carriage driver 33, a plasma actuator driver 34, and a paper feed driver 35.

The controller 30 centrally controls the respective devices of the printer 201. The controller 30 includes, for example, a CPU, a ROM that stores an executable basic control program and data relating to the basic control program in a non-volatile manner, a RAM that temporarily stores a program to be executed by the CPU and predetermined data, and other peripheral circuits.

The head driver 32 is coupled to a driving element 36 such as a piezoelectric element for ejecting ink. The driving element 36 is driven under the control of the controller 30, and causes ink to be ejected from the nozzle hole 213 by a required amount.

The carriage driver 33 is coupled to a carriage motor 37, and outputs a driving signal to the carriage motor 37 to operate the carriage motor 37 in a range instructed by the controller 30.

The plasma actuator driver 34 is coupled to each plasma actuator 220, and outputs a driving signal to the plasma actuator 220 to drive the plasma actuator 220 through the controller 30.

The paper feed driver 35 is coupled to a paper feed motor 38, and outputs a driving signal to the paper feed motor 38 to operate the paper feed motor 38 by an amount instructed by the controller 30. The printing medium 3 is transported in the transport direction by a predetermined amount in accordance with the operation of the paper feed motor 38.

To drive each plasma actuator 220, a high voltage is required. The printer 201 includes a driving voltage generator 40 that generates a driving voltage for driving the plasma actuator 220. The driving voltage generator 40 is coupled to the plasma actuator 220. Alternatively, the driving voltage generator 40 may be coupled to the plasma actuator driver 34.

With a serial printer, a flexible cable that transmits a head driving signal is arranged on the movable carriage 210. It is not desirable to additionally arrange high-voltage wiring for driving the plasma actuator 220 in the flexible cable because a problem may arise in distance for insulation, countermeasure for short-circuit, and countermeasure for noise.

Owing to this, in this embodiment, a low-voltage power supply line is arranged in the flexible cable, and the driving voltage generator 40 is mounted on the ink jet head 211 or the carriage 210. The driving voltage generator 40 uses its low-voltage power as an input voltage, and raises the input voltage to a high voltage.

When a piezoelectric element is used for the driving element 36, since the power supply line for driving the piezoelectric element is arranged in the flexible cable, a power for driving the piezoelectric element may be used as an input voltage to the driving voltage generator 40. Also when a thermal-type driving element is used for the driving element 36, a power for driving the thermal head may be used as an input voltage to the driving voltage generator 40 likewise. Of course, an independent low-voltage power line may be arranged in the flexible cable.

Similarly to the above-described embodiment, the controller 30 controls driving of the plasma actuator 220 via the plasma actuator driver 34.

As illustrated in FIGS. 21 and 22, for example, in comparison to a timing at which the driving element 36 of the ink jet head 211 is driven and ink is ejected, the controller 30 performs control to start the driving of the plasma actuator 220 earlier than the ejection start of ink. Also, the controller 30 performs control to end the driving of the plasma actuator 20 later than the ejection end of ink.

By driving the plasma actuators 220 earlier than the ejection start of ink as described above, airflows can be generated before ink is ejected. By ending the driving of the plasma actuator 220 later than the ejection end of ink, a mist staying during printing can be discharged.

A printing method of this embodiment is described next.

When the printer 201 performs printing, the controller 30 performs control on the head driver 32, the carriage driver 33, and the paper feed driver 35. Thus, by driving the driving element 36 while driving the carriage motor 37 to reciprocate the carriage 210, ink is ejected from the nozzle holes 213, and thus printing is performed on the printing medium 3.

After the printing is performed on the printing medium 3 through the reciprocation of the carriage 210, the paper feed motor 38 is driven to transport the printing medium 3 by a predetermined amount in the transport direction. Then, the printing is performed on the printing medium 3 again while the carriage 210 is moved.

In this case, the controller 30 outputs a driving signal to the plasma actuator 220, and causes the plasma actuator 220 to be driven. The plasma actuator 220 may be driven in any of the above-described ways.

Accordingly, since the airflow is generated by driving the plasma actuator 220, the air in the platen gap likely moves with the movement of the carriage 210, and a mist around the liquid ejection surface 212 can be discharged.

Also, as illustrated in FIG. 52, when the plurality of unit plasma actuators 220a to 220f are arranged, the controller 30 controls the unit plasma actuators 220a to 220f in accordance with the movement of the carriage 210.

As described above, the printer 201 according to the embodiment to which the invention is applied includes the ink jet head 211 that ejects liquid from the nozzle rows 214 being open in the liquid ejection surface 212 arranged on the surface facing the printing medium 3. Also, the printer 201 includes the plasma actuator 220 provided separately from the ink jet head 211, and the controller 30 that controls the ink jet head 211 and the plasma actuator 220. The controller 30 drives the plasma actuator 220 to generate an airflow for discharging a mist, which is generated when the nozzle row 214 ejects liquid, from an area between the liquid ejection surface 212 and the printing medium 3.

Accordingly, since the airflow is generated by driving the plasma actuator 220, the air in the platen gap likely moves with the movement of the ink jet head 211, and a mist of the liquid ejection surface 212 can be discharged. Thus, a mist unlikely adheres to the liquid ejection surface 212, and occurrence of a misprint can be reduced. Also, since the plasma actuator 220 is provided, a large-scale airflow generating device is not additionally required, and facilitation cost can be reduced.

In an example of this embodiment, the ink jet head 211 may be a serial-type ink jet head 211 that reciprocates in a main-scanning direction.

Accordingly, in the serial-type ink jet head 211 that reciprocates in the main-scanning direction, a mist around the liquid ejection surface 212 can be efficiently discharged.

Also, in this embodiment, the plasma actuator 220 may be arranged in the movement direction of the ink jet head 211.

Accordingly, when the ink jet head 211 reciprocates, a mist can be discharged.

In an example of this embodiment, the plasma actuator 220 may generate an airflow in the movement direction of the ink jet head 211.

Accordingly, an airflow can be generated in the movement direction of the ink jet head 211, and when the ink jet head 211 reciprocates, a mist can be discharged in the movement direction of the ink jet head 211.

In an example of this embodiment, the plasma actuator 220 may generate an airflow in a direction intersecting with the movement direction of the ink jet head 211.

Accordingly, an airflow can be generated in the direction intersecting with the movement direction of the ink jet head 211, and a mist can be discharged in the direction intersecting with the movement direction of the ink jet head 211.

In an example of this embodiment, the plasma actuator 220 may be configured such that the plurality of unit plasma actuators 220a to 220f are arranged in line in the movement direction of the ink jet head 211.

Accordingly, the unit plasma actuators 220a to 220f can be driven in accordance with the movement of the ink jet head 211.

In an example of this embodiment, the controller 30 may drive the unit plasma actuators 220a to 220f in accordance with the reciprocation of the ink jet head 211.

Accordingly, the unit plasma actuators 220a to 220f can be selectively driven as required in accordance with the reciprocation of the ink jet head 211.

In an example of this embodiment, the plasma actuator 220 may generate an airflow in the reciprocation direction of the ink jet head 211, and the controller 30 may reverse the airflow direction in accordance with the reciprocation of the ink jet head 211.

Accordingly, the unit plasma actuator 220 can generate the airflow in accordance with the reciprocation of the ink jet head 211.

In an example of this embodiment, the flushing area 217 that executes the flushing operation of the ink jet head 211, and the flushing-area plasma actuator 220g arranged in the flushing area 217 are further provided. The flushing-area plasma actuator 220g may generate an airflow in a direction so that a mist generated during flushing is directed toward an ink recovery box 217a of the flushing area 217.

Accordingly, by driving the flushing-area plasma actuator 220g, a mist generated during flushing can be discharged to the ink recovery box 217a of the flushing area 217. Also, flushing can be executed simultaneously for all nozzle rows 214, and throughput can be increased.

### Sixth Embodiment

A sixth embodiment of the invention is described next.

FIG. 54 is a schematic illustration of an ink jet head according to the sixth embodiment of the invention. Note that the same reference sings are applied to the same portions as those of the fifth embodiment, and the description thereof is omitted.

As illustrated in FIG. 54, mist recovery containers 250 are provided below the platen 202, on both sides of the ink jet head 211 in the transport direction of the printing medium 3. Each mist recovery container 250 is open in the platen 202.

A filter 252 that recovers a mist sent into the mist recovery container 250 is arranged in the mist recovery container 250. The filter 252 is attachable and detachable.

A plasma actuator 220 that generates an airflow to recover a mist in the platen gap is arranged on the platen 202.

In this embodiment, the plasma actuator 220 is driven when the carriage 210 is moved. Accordingly, an airflow flowing toward the mist recovery container 250 is generated in the mist recovery container 250 as indicated by an arrow in the drawing. With this airflow, a mist generated from the nozzle rows 214 enters the mist recovery container 250, and is recovered by the filter 252.

As described above, in this embodiment, the filter 252 that recovers a mist is provided on the downstream side of the airflow generated by the plasma actuator 220.

Accordingly, by driving the plasma actuator 220, a mist generated from the nozzle rows 214 can be recovered by the filter 252.

While the filter 252 is attachable and detachable in the sixth embodiment, the invention is not limited thereto. For example, the mist recovery container 250 can be entirely exchanged.

### Seventh Embodiment

A seventh embodiment of the invention is described next.

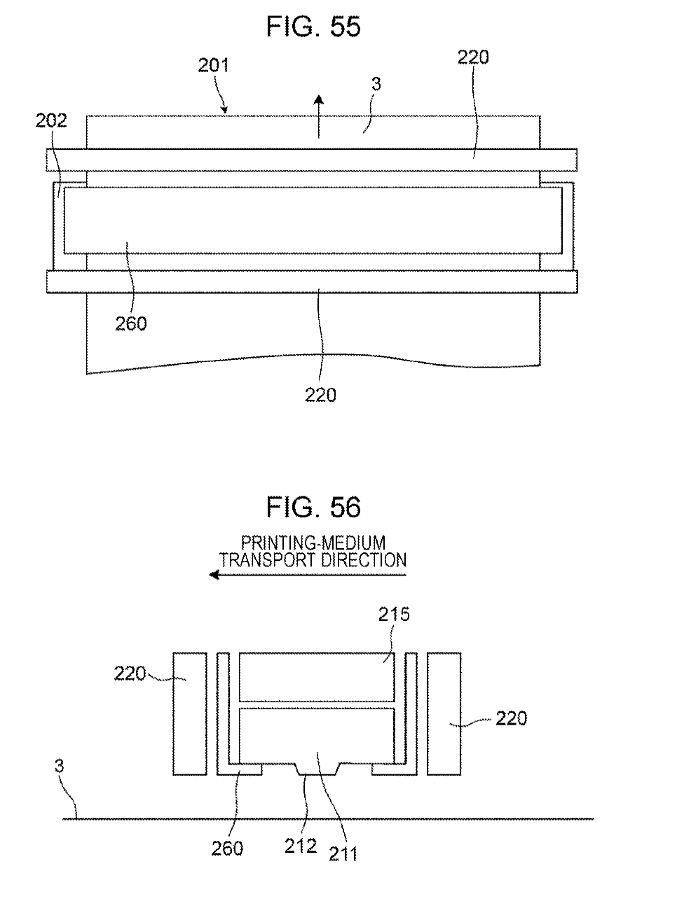

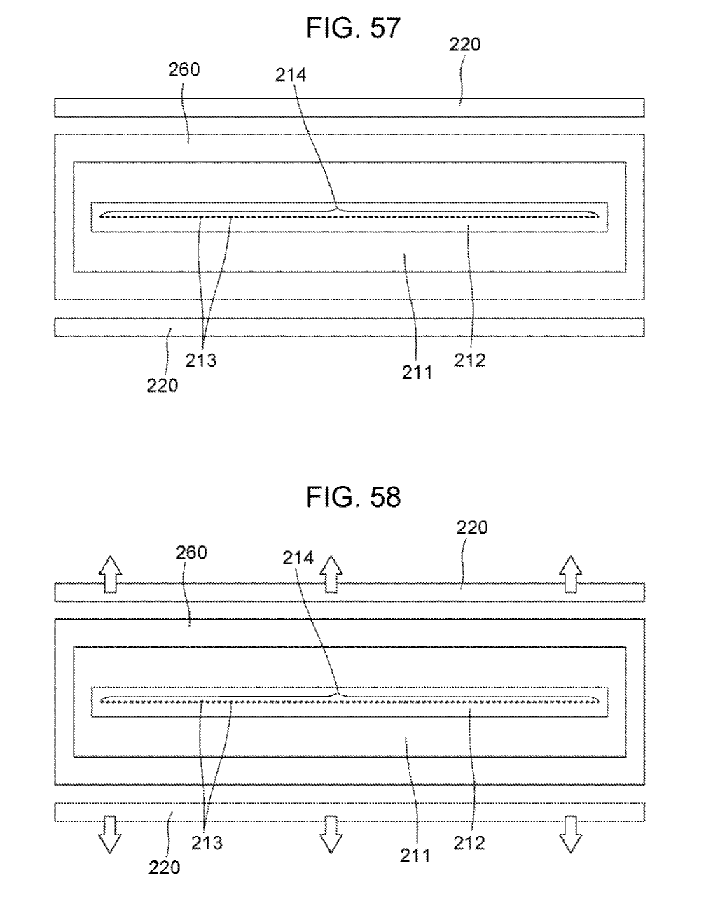

FIG. 55 is a schematic illustration of a printer according to the seventh embodiment. FIG. 56 is a schematic illustration of an ink jet head of the printer according to the seventh embodiment. FIG. 57 is a schematic illustration when viewed from a liquid ejection surface in FIG. 56. In the seventh embodiment, a case of using a line-type ink jet head extending in a direction intersecting with a transport direction of a printing medium is described. Note that the same reference sings are applied to the same portions as those of any of the above-described embodiments, and the description thereof is omitted. Also, the control configuration is described with reference to FIG. 53.

As illustrated in FIG. 55, a printer 201 includes a flat-plate-shaped platen 202. A predetermined printing medium 3 is transported on an upper surface of the platen 202 in a sub-scanning direction by a paper feed motor 38.

A support member 260 that extends in a direction intersecting with a transport direction of the printing medium 3 is provided above the platen 202. The support member 260 includes a linear ink jet head 211. The platen 202 may be provided with an ink discarding region for no-margin printing.

A surface of the ink jet head 211 facing the platen 202 is a liquid ejection surface 212. The liquid ejection surface 212 has a nozzle row 214 being open in the liquid ejection surface 212. The nozzle row 214 includes a plurality of nozzle holes 213 that eject ink on the printing medium 3.

The ink jet head 211 includes a driving element 36 such as a piezoelectric element for ejecting liquid from each of the nozzle holes 213. Also, an ink cartridge 215 that supplies the ink jet head 211 with ink is mounted on the support member 260.

The ink jet head 211, the ink cartridge 215, and the support member 260 are collectively called line-type ink jet head.

In this embodiment, an example of using a single-color ink cartridge 215 and using ink as the liquid is described. Alternatively, the ink cartridge 215 may be arranged at a location other than the support member 260.

For example, a flushing area 217 of the ink jet head 211 is provided below the platen 202. The platen 202 is retractable from a position below the ink jet head 211. While the platen 202 is retracted, by ejecting ink from the nozzle holes 213 of the ink jet head 211, ink increased in viscosity is discharged in the flushing area 217.

Also, two plasma actuators 220 are arranged on both sides of the ink jet head 211 in the transport direction of the printing medium 3. The plasma actuators 220 are arranged in a direction intersecting with the transport direction of the printing medium 3.

FIG. 58 illustrates an example in which the plasma actuators 220 generate airflows.

As illustrated in FIG. 58, the plasma actuators 220 are arranged to generate airflows in the transport direction of the printing medium 3. In this embodiment, the plasma actuators 220 are configured of two plasma actuators 220 arranged so that airflow generation directions of the plasma actuators 220 are opposite to each other.

With this configuration, an airflow can be generated on both sides of the ink jet head 211, to either of both directions in the transport direction of the printing medium 3.

FIG. 59 illustrates an example of generating airflows in the flushing area.

As illustrated in FIG. 59, when flushing is performed in the flushing area 217 while the platen 202 is retracted from the position below the ink jet head 211, the plasma actuators 220 are driven. In this case, the plasma actuators 220 generate airflows toward the ink jet head 211.

Accordingly, by driving the plasma actuators 220, a mist generated during flushing can be discharged to the ink recovery box 217a of the flushing area 217.

Alternatively, the plasma actuators 220 may generate airflows in a direction perpendicular to the paper face of FIG. 59.

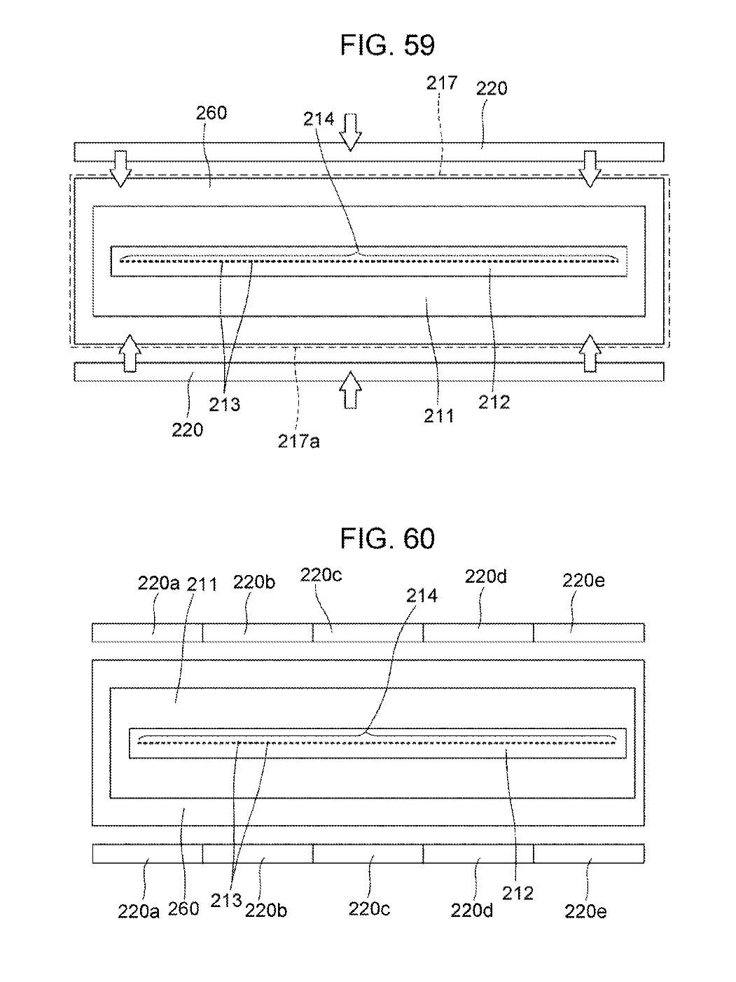

FIG. 60 illustrates an example in which each plasma actuator 220 is configured of a plurality of unit plasma actuators 220a to 220e arranged in line.

As illustrated in FIG. 60, the unit plasma actuators 220a to 220e generate airflows on both sides in the transport direction of the printing medium 3.

By generating the airflows in this way, the air in the platen gap likely moves, and a mist around the liquid ejection surface 212 is discharged.

Also, by arranging the plurality of unit plasma actuators 220a to 220e in line, the unit plasma actuators 220a to 220e can be individually driven.

For example, with the controller 30, the unit plasma actuators 220a to 220e are driven in accordance with the width dimension of the printing medium 3. That is, by individually driving the unit plasma actuators 220a to 220e in a region where the printing medium 3 is present, airflows can be generated only in a region where ink is ejected.

A printing method of this embodiment is described next.

When the printer 201 performs printing, the controller 30 performs control on the head driver 32 and the paper feed driver 35. Thus, by driving the driving element 36 while driving the paper feed motor 38 to transport the printing medium 3 in the transport direction, ink is ejected from the nozzle holes 213, and thus printing is performed on the printing medium 3.

In this case, the controller 30 outputs a driving signal to the plasma actuator 220, and causes the plasma actuator 220 to be driven.

Accordingly, by driving the plasma actuator 220 and hence generating the airflows toward the printing medium 3, a mist around the liquid ejection surface 212 can be discharged.

As described above, in the embodiment to which the invention is applied, the ink jet head 211 is a line-type ink jet head extending in the direction intersecting with the transport direction of the printing medium.

Accordingly, by driving the plasma actuator 220 and generating the airflows, the air in the platen gap likely moves with the transport of the printing medium 3, and a mist around the liquid ejection surface 212 can be discharged. Thus, a mist unlikely adheres to the liquid ejection surface 212, and occurrence of a misprint can be reduced. Also, since the plasma actuator 220 is provided, a large-scale airflow generating device is not additionally required, and facilitation cost can be reduced.

In an example of this embodiment, the plasma actuator 220 may be arranged in a direction intersecting with the transport direction of the printing medium 3.

Accordingly, in the line-type ink jet head 211, the plasma actuator 220 can discharge a mist around the liquid ejection surface 212.

In an example of this embodiment, the plasma actuator 220 may generate an airflow in the transport direction of the printing medium 3.

Accordingly, by driving the plasma actuator 220, the airflow in the transport direction of the printing medium 3 can be generated, and a mist around the liquid ejection surface 212 can be discharged.

In an example of this embodiment, the plasma actuator 220 may be configured such that the plurality of unit plasma actuators 220a to 220e are arranged in line in a direction intersecting with the transport direction of the printing medium 3.

Accordingly, since the plurality of unit plasma actuators 220a to 220e are arranged, only at least one of the unit plasma actuators 220a to 220e corresponding to the nozzle that ejects ink can be individually driven.

In an example of this embodiment, the controller 30 may drive the unit plasma actuators 220a to 220e in accordance with the width dimension of the printing medium 3.

Thus, by individually driving the unit plasma actuators 220a to 220e in the region where the printing medium 3 is present, airflows can be generated only in a range of the printing medium 3 where ink is ejected.

The above-described embodiments are merely examples of specific modes to which the invention is applied, and it is not intended to limit the invention. The invention can be applied to a mode different from the above-described embodiments.

### REFERENCE SIGNS LIST

1 printer
2 platen
3 printing medium
5 guide shaft
10 carriage
11 ink jet head
12 liquid ejection surface
13 nozzle hole
14 nozzle row
15 ink cartridge
16 head unit
20 plasma actuator
30 controller
40 driving voltage generator
52 filter

1. A printer, comprising:
a head unit including
an ink jet head that ejects liquid from a nozzle row being open in a liquid ejection surface arranged on a surface facing a printing medium, and
a support member on which the ink jet head is mounted;
a plasma actuator that generates an airflow with respect to a platen gap; and
a controller that controls liquid ejection from the nozzle row, and airflow generation of the plasma actuator.

2. The printer according to claim 1, wherein the plasma actuator is arranged on the liquid ejection surface.

3. The printer according to claim 1, wherein the plasma actuator is arranged beside the nozzle row.

4. The printer according to claim 2, wherein the plasma actuator includes at least two plasma actuators arranged on the liquid ejection surface with the nozzle row interposed therebetween.

5. The printer according to claim 1, wherein the plasma actuator is arranged on the support member.

6. The printer according to claim 1, wherein the plasma actuator is arranged at a position at a distance larger than a distance between the liquid ejection surface and the printing medium.

7. The printer according to claim 1, wherein the plasma actuator is arranged on a surface intersecting with the liquid ejection surface.

8. The printer according to claim 1, wherein an airflow generation region by the plasma actuator is longer than the nozzle row.

9. The printer according to claim 1, wherein the controller drives the plasma actuator to generate an airflow so that liquid droplets which are generated when the liquid is ejected from the nozzle row and which float around without arriving at the printing medium do not stay around the liquid ejection surface.

10. The printer according to claim 1, wherein the controller drives the plasma actuator to generate an airflow when the liquid is not ejected from the nozzle row.

11. The printer according to claim 1, wherein the controller does not drive the plasma actuator when the liquid is ejected from the nozzle row for printing.

12. The printer according to claim 1, wherein the controller drives the plasma actuator to generate an airflow during a flushing operation by the head unit.

13. The printer according to claim 1, further comprising:
a driving voltage generator that generates a driving voltage for driving the plasma actuator,
wherein the driving voltage generator is mounted on the ink jet head.

14. The printer according to claim 13, wherein the ink jet head includes wiring for supplying an ink jet driving voltage for driving the head unit, and the driving voltage generator generates a voltage for driving the plasma actuator by using the ink jet driving voltage.

15. The printer according to claim 1,
wherein the support member is a carriage configured to reciprocate in a main-scanning direction, and
wherein the plasma actuator is arranged beside the nozzle row in a movement direction of the carriage.

16. The printer according to claim 15, wherein the plasma actuator is arranged beside the nozzle row to intersect with the nozzle row in a direction intersecting with the movement direction of the carriage.

17. The printer according to claim 15, wherein the controller controls driving of the plasma actuator to generate an airflow in accordance with the movement direction of the carriage.

18. The printer according to claim 1, wherein the ink jet head is a line-type ink jet head extending in a direction intersecting with a transport direction of the printing medium.

19. The printer according to claim 18, wherein the line-type ink jet head is configured such that a plurality of unit ink jet heads are arranged in a staggered manner.

20. The printer according to claim 19, wherein the plasma actuator is arranged for each of the unit ink jet heads.

21. The printer according to claim 18, wherein the plasma actuator includes a plurality of plasma actuators arranged in line.

22. The printer according to claim 21, wherein the controller individually controls the plurality of plasma actuators to drive a plasma actuator corresponding to a nozzle that ejects the liquid.

23. The printer according to claim 1,
wherein the plasma actuator is arranged separately from the ink jet head and the support member, and
wherein the controller drives the plasma actuator to generate an airflow for discharging a mist which is generated when the liquid is ejected from the nozzle row, from an area between the liquid ejection surface and the printing medium.

24. The printer according to claim 23, further comprising:
a flushing area where a flushing operation of the ink jet head is executed; and a flushing-area plasma actuator arranged in the flushing area,
wherein the flushing-area plasma actuator generates an airflow in a direction so that a mist generated during flushing is directed toward an ink recovery box in the flushing area.

25. A head unit, comprising:
a liquid ejection surface arranged on a surface facing a printing medium;
a nozzle row that is open in the liquid ejection surface, and that ejects liquid to the printing medium; and
a plasma actuator,
wherein the plasma actuator generates an airflow with respect to a space where the nozzle row ejects the liquid.
